(19) United States
(12) Patent Application Publication
(10) Pub. No.: US 2018/0342030 A1
(43) Pub. Date: Nov. 29, 2018

(54) NEUTRAL RADISTRICTING USING A MULTI-LEVEL WEIGHTED GRAPH PARTITIONING ALGORITHM

(71) Applicant: The Research Foundation for the State University of new York, Binghamton, NY (US)

(72) Inventors: Daniel Blyth Magleby, Binghamton, NY (US); Daniel B. Mosesson, Baltimore, MD (US)

(21) Appl. No.: 15/987,598

(22) Filed: May 23, 2018

Related U.S. Application Data
(60) Provisional application No. 62/510,529, filed on May 24, 2017.

(51) Int. Cl. G06Q 50/26; G06Q 10/04; G06F 17/18

(52) U.S. Cl. CPC G06Q 50/26; G06F 17/18; G06Q 10/04

(57) ABSTRACT

A system and method for partitioning a map into a plurality of disjoint regions each representing a respective continuous bounded geographic region, comprising: receiving a data set representing a geographic region having geographic variations, and a partitioning objective; partitioning the data so that the partitioning objective is met, using a distinct condition, to produce a plurality of partitioned geographic regions, dependent on at least the geographic variations and characteristics of the data and the initial condition. A plurality of initial conditions or distinctness criteria applied to the partitioning as the distinct criterion, to produce a plurality of different maps. The plurality of maps may then be compared according to a fitness criterion.

### CROSS REFERENCE TO RELATED APPLICATION

The present application is a non-provisional of, and claims benefit of priority under 35 U.S.C. § 119(e) from, U.S. Provisional Patent Application No. 62/510,529, filed May 24, 2017, the entirety of which is expressly incorporated herein by reference.

### FIELD OF THE INVENTION

The present invention relates to the field of map analysis, and in particular a technology for determining bias in construction of a map, and defining maps which reflect low bias.

### BACKGROUND OF THE INVENTION

Computers hold the potential to draw legislative districts in a neutral way. Existing approaches to automated redistricting may introduce bias and encounter difficulties when drawing districts of large and even medium-sized jurisdictions.

When discretion is used in the creation of a map, intentional or unintentional bias may occur. In election district maps, there is at least on incentive for a majority party to either dilute minorities in a manner that effectively reduces their representation, or to con concentrate minorities such that their overall representation is diminished. At least in electoral maps, the intentional use of race as a factor is a U.S. Constitutional violation. See, Cooper v. Harris 581 U.S. ______ (dkt. 15-1262, 2017), www.supremecourt.gov/opinions/16pdf/15-1262_db8e.pdf. The earlier Cromartie II case, Easley v. Cromartie, 532 U. S. 234 (2001) found that those challenging a redistricting had to come forward with an alternative redistricting map that served the legislature's political objective as well as the challenged version without producing the same racial effects. Cooper v. Harris loosened the requirement for an alternate acceptable map, but did not eliminate that as a consideration.

Geographically defined legislative districts present a temptation for politically motivated mapmakers. It has long been understood that those responsible for drawing districts may pervert mechanisms of representation by drawing the boundaries of districts in ways that advantage (or disadvantage) certain groups.

A recent example illustrates this point. In 2010, Scott Walker won election as governor of Wisconsin. In addition to Walker's victory, Republicans running for seats in Wisconsin's State Senate and Assembly benefited from a wave of discontent with Democrats and established majorities in both chambers of Wisconsin's state legislature. The victory was well timed because following the census in 2010, Walker and legislative Republicans had the opportunity to re-draw the state's state legislative and congressional districts in advance of the 2012 election without meaningful Democratic opposition. Their result was a set legislative districts that ensured significant Republican majorities in Wisconsin's legislature and congressional delegation. When a group of Democratic voters challenged the map of state-legislative districts in federal court, an expert testifying on behalf of the Democrats argued that the Republican drawn districts potentially undermined a core principal of representative democracy, majority rule. The expert argued that it would take a “political earthquake” for Democrats to win a majority of seats in the legislature even though Wisconsin Democrats frequently won a majority of votes cast in legislative elections and in state-wide races (Johnson 2016a). Wisconsin Republicans countered that their advantage grew out of the concentration of Democrats in urban areas, and the map they drew simply reflected the more efficient distribution of Republicans in suburban and rural areas (Johnson 2016b). The question left for the panel of federal judges hearing the case was whether the Republicans had pushed their advantage too far.

Redistricting is a particularly complex problem. So complex, that discovering political bias in a set of legislative maps has been an intractable problem. In particular, analysts encounter difficulties discerning whether bias arises as a consequence of the geographic distribution of voters or through some external manipulation on the part of political actors.

In 1961, economist and future Nobel laureate William Vickrey posited that it was possible to eliminate “chicanery” from the way legislative districts are drawn. He suggested that a neutral algorithm could solve the redistricting problem, the process of dividing a set of geographic units into a smaller number districts, in an “automatic and impersonal” way (110). In the years and decades that followed, computers made it possible for scholars to implement methods for developing optimal, neutral maps of legislative districts (see Bozkaya, Erkut and Laporte 2003; Browdy 1990; Chou and Li 2006; Garfinkel and Nemhauser 1970; Nagel 1965; Weaver and Hess 1963 and Fryer Jr and Holden 2011). At the same time, analysts recognized that retrieving an unbiased counterfactual of a jurisdiction's legislative districts is useful in a variety of applications (see Chen and Cottrell 2014; Chen and Rodden 2013; Cho and Liu 2016; Cirincione, Darling and O'Rourke 2000; Engstrom and Wildgen 1977; Fifield et al. 2016; McCarty, Poole and Rosenthal 2009; O'Loughlin and Taylor 1982). In spite of Vickrey's assertion that developing a neutral process to draw legislative districts would be “not at all difficult (1961, 110), computer-automated redistricting turned out to be at best a challenging problem and at worst an intractable one in complex redistricting scenarios. There are at least two difficult automated processes encountered; first, an algorithm designed to generate maps of districts may take a biased sample of all possible legislative maps (Altman et al. 2015); and second, many of the most interesting and important redistricting problems are so complex that automated methods may fail to efficiently produce a meaningful distribution of possible alternative maps. One possible solution is to implement alternative algorithms that are less efficient on more powerful computers; however, to generate a meaningful number of maps some scholars have resorted to using super-computers (Remmert 2016).

The “efficiency gap” standard proposed by McGhee (2014) and Stephanopoulos and McGhee (2015) proceeds from the insight that both the winner and loser of an election almost always “waste” votes that play no role in determining the outcome. For instance, they explain that in an election where 100 people cast ballots and the winner receives 60 votes, the winner has wasted 10 votes in excess of the 50 votes needed to win (setting aside ties for sake of simplicity) and the loser has wasted all 40. The efficiency gap is the difference between the wasted votes for each side divided by the number of votes cast, in this case (40−10)/100=0.3 or 30%. In fair maps, plaintiffs claim, the wasted votes on each side balance out so that the net efficiency gap is no more than 8%, a threshold empirically derived from examining election results across a number of states (Stephanopoulos and McGhee 2015, p. 837). As a matter of simple intuition, this claim is appealingly straightforward. Gerrymanders function by inequitably allocating votes in some fashion, so the notion that this can be captured by observing wasted votes above and below the number needed to win seems reasonable.

Stephanopoulos and McGee maintain that one advantage of the efficiency gap is that it simultaneously addresses both maneuvers used in gerrymandering, “packing” and “cracking.” Packing concentrates large numbers of one party in as few districts as possible, leaving their strength depleted in surrounding districts. Cracking, by contrast, divides partisans into healthy minorities in many districts, limiting a party's ability to win many districts. By counting votes wasted by winners (packing) and by losers (cracking), the efficiency gap purportedly combines both processes into a single accounting metric. The efficiency gap has another noteworthy empirical property. Assuming equal numbers of votes cast in each district, its calculation reduces to a simple equation: Efficiency Gap=Seat Margin−(2×Vote Margin)

In this case, seat and vote margin are both measured by percentage-point deviations from 50%. So in systems where the efficiency gap=0, a party that wins 55% of votes should receive 60% of seats, and a party that wins 60% of votes should receive 70% of seats, and so on. Political scientists will recognize the term, 2×Vote Margin, as the “swing ratio” of a basic votes-to-seats formula. As a normative proposition, the basis for a swing ratio of two versus anything else is unclear (McGann et al. 2015). Rather, it is merely an empirical byproduct of how the efficiency gap is produced. As it happens, equal turnout rarely, if ever, occurs across multiple legislative districts even in high-turnout elections.

An alternative measure is the median-mean comparison introduced by Michael D. McDonald and several coauthors (McDonald and Best (2015); McDonald, Krasno, Best 2011). Unlike the efficiency gap, the median-mean comparison is focused wholly on packing or what McDonald and Best (2015) refer to as “differential packing.” It further differs from Stephanopoulos and McGhee's characterization of their measure by giving special attention to the question of partisan control—holding a majority of seats—of a legislature (or legislative delegation). This emphasis grounds the median-mean comparison to the principle of majority rule, at least as a matter of its ability to detect harm to voters. As a result, Wisconsin is a promising setting to employ this comparison because its statewide elections have been won by candidates of both parties. In fact, Wisconsin's statewide elections have been remarkably competitive with just two of the 13 races decides by more than 7 percentage points (President Obama's 14-point win in 2008, and Republican Attorney General J. B. Van Hollen's 16-point reelection victory in 2010). This attention to partisan control leads McDonald and his coauthors to focus on the median legislative district in a jurisdiction as measured by distribution of the parties' share of the two-party vote across districts since the median district is where partisan control is decided. For instance, if the 50^{th} most Democratic district of the 99 Assembly districts in Wisconsin typically gives 45% of its vote to Democratic candidates, Democratic voters' chances of winning control of the legislature or delegation are fairly remote. That level of Democratic performance in the median district is unremarkable when the party also averages 45% of the vote across districts. But what if the Democrats were to average 51% of the vote? McDonald et al. argue that the disparity between a party's mean performance across legislative districts versus its performance in the median district represents the asymmetry bias in a map (see also Edgeworth 1898, p. 534-6; Butler 1952. P. 276 n.1; Erikson 1972, p. 1237). So, if the Democratic mean and median district percentage are both 45% the map is exactly fair. If the mean district is less than 45% Democratic, the map favors the Democrats because they are closer to partisan control than their mean share of votes across all districts suggests. If the mean district is more than 45% Democratic, the map's bias benefits Republicans. McDonald and his coauthors contend that their method fares well in a variety of settings and delivers fairly stable results even when the elections themselves do not.

Finally, because the median-mean comparison explicitly uses election results to measure the partisan complexion in districts its promoters insist that jurisdiction-wide elections—such as presidential, U.S. senatorial, or statewide constitutional offices—hold the most probative value when comparing the median and mean district percentages (McDonald and Best 2015, pg. 318 n.8). The difficulty with legislative elections themselves is that they are susceptible to all sorts of idiosyncrasies from uncontested seats and lightly contested seats to exogenous local factors that might particularly help or hurt a candidate or candidates. Those factors are evident in Wisconsin for a third of its Assembly races were uncontested by one of the major parties between 2008 and 2014, and most of the remaining races were lightly contested at best.

The efficiency gap is a measure of performance in legislative elections and it most frequently uses legislative election returns such as congressional results (McGhee 2014). But its proponents appear to be largely agnostic on the type of election returns necessary to detect inefficiencies; in Whitford the Mayer Report uses presidential returns while the Jackman Report augments results from elections for state assemblies with presidential returns to input values for uncontested districts.

Thus, the creation of a biased districting map is relatively easy, as inhomogeneous clusters of populations with specified characteristics may be group together or dispersed in an intentional manner, often based on historical voting results. However, the creation of an unbiased map is a harder problem, when additional criteria that might favor population clusters are imposed.

See US 20130218789 and US 20080177555, each of which is expressly incorporated herein by reference in its entirety.

In mathematics, the graph partition problem is defined on data represented in the form of a graph G=(V,E), with V vertices and E edges, such that it is possible to partition G into smaller components with specific properties. See, en.wikipedia.org/wiki/Graph_partition, expressly incorporated herein by reference in its entirety.

For instance, a k-way partition divides the vertex set into k smaller components. A “good” partition is defined as one in which the number of edges running between separated components is small. Uniform graph partition is a type of graph partitioning problem that consists of dividing a graph into components, such that the components are of about the same size and there are few connections between the components. See Buluc et al. (2013).

Typically, graph partition problems fall under the category of NP-hard problems. Solutions to these problems are generally derived using heuristics and approximation algorithms. However, uniform graph partitioning or a balanced graph partition problem can be shown to be NP-complete to approximate within any finite factor. Even for special graph classes such as trees and grids, no reasonable approximation algorithms exist, unless P=NP. Grids are a particularly interesting case since they model the graphs resulting from Finite Element Method (FEM) simulations. When not only the number of edges between the components is approximated, but also the sizes of the components, it can be shown that no reasonable fully polynomial algorithms exist for these graphs.

Consider a graph G=(V, E), where V denotes the set of n vertices and E the set of edges. For a (k,v) balanced partition problem, the objective is to partition G into k components of at most size v·(n/k), while minimizing the capacity of the edges between separate components. Also, given G and an integer k>1, partition V into k parts (subsets) V₁, V₂, . . . , Vₖ such that the parts are disjoint and have equal size, and the number of edges with endpoints in different parts is minimized. Such partition problems have been discussed in literature as bicriteria-approximation or resource augmentation approaches. A common extension is to hypergraphs, where an edge can connect more than two vertices. A hyperedge is not cut if all vertices are in one partition, and cut exactly once otherwise, no matter how many vertices are on each side.

For a specific (k, 1+ε) balanced partition problem, a minimum cost partition of G into k components is sought, with each component containing maximum of (1+ε)·(n/k) nodes. The cost of this approximation algorithm is compared to the cost of a (k,1) cut, wherein each of the k components must have exactly the same size of (n/k) nodes each, thus being a more restricted problem. Thus,

$${max}_{i} \vert {V}_{i} \vert \leq ( 1 + ɛ ) ⌈ \frac{\vert V \vert}{k} ⌉ .$$

The (2,1) cut is the minimum bisection problem and it is NP complete.

A 3-partition problem is now assessed wherein n=3k, which is also bounded in polynomial time. Now, a finite approximation algorithm for (k,1)-balanced partition is assumed, then, either the 3-partition instance can be solved using the balanced (k,1) partition in G or it cannot be solved. If the 3-partition instance can be solved, then (k,1)-balanced partitioning problem in G can be solved without cutting any edge. Otherwise if the 3-partition instance cannot be solved, the optimum (k, 1)-balanced partitioning in G will cut at least one edge. An approximation algorithm with finite approximation factor has to differentiate between these two cases. Hence, it can solve the 3-partition problem which is a contradiction under the assumption that P=NP. Thus, it is evident that (k,1)-balanced partitioning problem has no polynomial time approximation algorithm with finite approximation factor unless P=NP.

The planar separator theorem states that any n-vertex planar graph can be partitioned into roughly equal parts by the removal of O(√n) vertices. This is not a partition in the sense described above, because the partition set consists of vertices rather than edges. However, the same result also implies that every planar graph of bounded degree has a balanced cut with O(√n) edges.

Since graph partitioning is a hard problem, practical solutions are based on heuristics. There are two broad categories of methods, local and global. Well-known local methods are the Kernighan-Lin algorithm, and Fiduccia-Mattheyses algorithms, which were the first effective 2-way cuts by local search strategies. Their major drawback is the arbitrary initial partitioning of the vertex set, which can affect the final solution quality. Global approaches rely on properties of the entire graph and do not rely on an arbitrary initial partition. The most common example is spectral partitioning, where a partition is derived from the spectrum of the adjacency matrix.

A multi-level graph partitioning algorithm works by applying one or more stages. Each stage reduces the size of the graph by collapsing vertices and edges, partitions the smaller graph, then maps back and refines this partition of the original graph. A wide variety of partitioning and refinement methods can be applied within the overall multi-level scheme. In many cases, this approach can give both fast execution times and very high quality results. One widely used example of such an approach is METIS, a graph partitioner, and hMETIS, the corresponding partitioner for hypergraphs.

Given a graph G=(V,E) with adjacency matrix A, where an entry Aᵢⱼ implies an edge between node and, and degree matrix D, which is a diagonal matrix, where each diagonal entry of a row, dᵢᵢ, represents the node degree of node i. The Laplacian matrix L is defined as L=D−A. Now, a ratio-cut partition for graph G=(V,E) is defined as a partition of V into disjoint U, and W, minimizing the ratio:

of the number of edges that actually cross this cut to the number of pairs of vertices that could support such edges.

In such a scenario, the second smallest eigenvalue (yields a lower bound on the optimal cost (c) of ratio-cut partition with. The eigenvector (V₂) corresponding to, called the Fiedler vector, bisects the graph into only two communities based on the sign of the corresponding vector entry. Division into a larger number of communities can be achieved by repeated bisection or by using multiple eigenvectors corresponding to the smallest eigenvalues.

Minimum cut partitioning however fails when the number of communities to be partitioned, or the partition sizes are unknown. For instance, optimizing the cut size for free group sizes puts all vertices in the same community. Additionally, cut size may be the wrong thing to minimize since a good division is not just one with small number of edges between communities. This motivated the use of Modularity (Q) as a metric to optimize a balanced graph partition.

Another objective function used for graph partitioning is Conductance which is the ratio between the number of cut edges and the volume of the smallest part. Conductance is related to electrical flows and random walks. The Cheeger bound guarantees that spectral bisection provides partitions with nearly optimal conductance. The quality of this approximation depends on the second smallest eigenvalue of the Laplacian λ₂.

Spin models have been used for clustering of multivariate data wherein similarities are translated into coupling strengths. The properties of ground state spin configuration can be directly interpreted as communities. Thus, a graph is partitioned to minimize the Hamiltonian of the partitioned graph. The Hamiltonian (H) is derived by assigning the following partition rewards and penalties: Reward internal edges between nodes of same group (same spin); Penalize missing edges in same group; Penalize existing edges between different groups; and Reward non-links between different groups.

Additionally, Kernel Principal Component Analysis (PCA) based Spectral clustering takes a form of least squares Support Vector Machine framework, and hence it becomes possible to project the data entries to a kernel induced feature space that has maximal variance, thus implying a high separation between the projected communities. Some methods express graph partitioning as a multi-criteria optimization problem which can be solved using local methods expressed in a game theoretic framework where each node makes a decision on the partition it chooses.

### SUMMARY OF THE INVENTION

The present technology provides a method for evaluating just how “perverse”, i.e., the likelihood that the boundaries are established based on a strong bias distinct from the legitimate goal of setting the boundaries, a set of legislative districts are. The method relies on the development of a counterfactual—a null distribution of possible redistricting outcomes. To have confidence that an observed map is extreme enough to warrant remedy, it is necessary to characterize a representative distribution of possible redistricting outcomes. In practice, this requires using a computer to draw a large number of alternative maps according to set of neutral criteria. (Neutral, in this context, means that the process of generating the counterfactual only considers the legitimate secondary [discretionary] criteria, after the primary [objective] criteria are met, e.g., in an electoral map, constitutionally relevant characteristics of the geography it divides into legislative districts: contiguity and population parity. In comparing an observed outcome to a large set of neutral alternatives, the degree to which observed maps differ from expected in a neutral process is determined). In practice, state-level maps of legislative districts are drawn by state legislatures or redistricting commissions.

The present technology algorithm may be used to develop a neutral comparison against which analysis may compare actual maps. Since it is efficient enough to draw thousands, millions, or even billions of maps, it allows an analyst to characterize the likelihood that a particular map would emerge through a fair and neutral process. Thus, the technology allows a determination of whether a map which meets a first geographically-related criterion, is reasonably efficient with respect to other possible maps that meet the same criteria. For example, a complexity or bias metric is used to determine reasonableness, and to the extent that the criteria is scalar, to compare how well various alternate maps also meet the criteria.

Similarly, where there are competing criteria, the technology may be used to compare alternates with respect to a quality, bias or complexity metric, for example.

Further, the technology may also be used to generate an optimal map, according to a set of geographically-related primary criteria, which is optimal with respect to a qualitative secondary criteria distinct from the primary criteria. For example, in electoral maps, it is considered appropriate to concentrate a global minority into districts where they are a majority, wherein the efficiency of this selection is based on the concept of predicted surplus votes; since the electoral outcome is binary, and within a district the majority vote prevails, it is inefficient to design a district with more that ˜53% majority voters (where the option exists to allocate these same voters to another district where they might become part of the majority). Accordingly, assuming population distribution cooperates, the number of legislators for each party for the entire political structure will be roughly proportionate to the numbers of voters for each party. On the other hand, when a surplus of minority voters is packed into a district, their overall power will be reduced, since excess votes within any district are “wasted”. Thus, if the goal of the map is to provide predicted proportionate representation (assuming individual voting remains unchanged over time), the optimal map would be one which draws district boundaries, where possible, to include minority prevailing districts with a small surplus of minority voters. (The surplus addresses the fact that voting is not constant, and the measures are statistical.

One embodiment of the technology applies a multi-level weighted graph partitioning algorithm to geographic data. It (1) simplifies the data into a graph, (2) in iterative steps simplifies the graph further; (3) it divides the graph into the desired number of districts or geographic regions; (4) it then projects the district information back into the original data; (5) it refines the districts so that they meet the both the primary and secondary criteria (e.g., political and legal or constitutional constraints); (6) it repeats the process as many times as an analyst desires.

The technology could be used to develop micro targeted marketing materials for advertising or political campaigns. Face-to-face canvass has been shown to be the most effective method of micro targeting; however, the process of developing routes by which canvassers take can be time consuming. The algorithm can create geographically compact routes for canvassers in which equal numbers of micro-targeted individuals reside. The algorithm would add considerable efficiency to the process of micro targeting one of the fastest growing areas in marketing.

The technology could also be used to organize groups that must be concentrated in relatively compact geographic spaces—for example, when assigning athletes to youth sports teams. Youth league teams generally need roughly equal numbers of players, and to facilitate participation, should be drawn from relatively compact geographic spaces. The algorithm could organize participants into equally sized teams that are all centered in the same neighborhood.

The technology also has applications for quickly and efficiently developing routes by which package delivery services like UPS make deliveries. Package delivery services need to divide deliveries evenly across trucks and drivers. Likewise, by assigning trucks to make deliveries in geographically compact areas the service saves money on fuel and vehicle maintenance. Since the number of packages delivered varies every day, the most efficient routes will also change. The algorithm can quickly and efficiently develop routes in which trucks make similar amounts of deliveries into relatively compact geographic areas. The algorithm is efficient enough to allow companies to change their routes daily in response to changes in the volume of deliveries they need to make.

The technology could also be useful in determining the boundaries of new media markets as population shifts. Media markets are geographically contiguous spaces that share similar characteristics with electoral districts. As population shifts, it may be necessary to redefine the boundaries of markets or break up existing markets. The algorithm can produce a set of neutrally drawn media markets.

The technology is much more efficient than alternative approaches to the same problem. The improvement in efficiency means that (1) analysts may use more detailed data to develop maps; (2) analysts can evaluate maps in larger more complex settings; (3) analysis can use standard desktop or laptop computers to evaluate maps as opposed to large, costly computing clusters or super computers. The algorithm exhibits no indication of bias in the way it draws maps of districts. Alternative approaches have been shown to draw particular types of districts which precludes a valid comparison to maps analysts may wish to evaluate.

The present technology avoids many of the issues related to bias and efficiency exhibited by alternative approaches to automated redistricting. To demonstrate the advantages of the technology algorithm, first, the algorithm is subjected to tests designed to reveal bias and find no evidence of bias in the way the algorithm draws districts. In one test, the algorithm is applied to a redistricting scenario designed to reveal whether the algorithm produces districts of one variety more often than districts of another variety, which it does not. As another test for bias compares the sample of maps drawn by the technology to a known distribution of possible districts. In this case, the algorithm retrieves an accurate approximation of the known distribution. The algorithm is remarkably efficient. Using asymptotic analysis, a technique used by computer scientists to evaluate the complexity of algorithms, the algorithm was compared to a commonly used alternative, and shown to be many orders of magnitude more efficient than the alternative approach. In short, the technology retrieves an approximation of the null distribution with no indication of bias in a fraction of the time it takes alternative approaches to produce maps of similar jurisdictions.

To address the redistricting problem, the present technology relies on graph partitioning methods developed in computer science. The class of graph partitioning algorithms upon which the method is based are well understood by computer scientists (Hendrickson and Leland 1995; Karypis and Kumar 1995, 1998; Kernighan and Lin 1970); however, applying these processes to the political problem of redistricting, and other similar map generation problems is new. In computer science applications, graph partitioning algorithms are used by programmers to divide related computational tasks between a computer's processor. In applying this to discretionary results in which the ultimate outcome may be determined by manual, random or biased selection among available alternates, the technique differs.

The technology may be applied to the substantive problem of congressional districts in a medium (Mississippi), large (Virginia), and very large (Texas) state. These states each have significant minority populations and a history of using the redistricting process to discriminate against those minority groups. For example, the algorithm draws 10,000 distinct maps using census block-level geographic and demographic data. The simulated maps allow estimation of a null distribution of the number of majority-minority districts expected from a neutral redistricting process within each state. Each state's 2012 congressional map has more majority-minority districts than expected from a neutral redistricting process. The finding is significant because, since its decision in Shaw v. Reno, 509 U.S. 630 (1993), the Supreme Court has been skeptical of redistricting plans that go to extreme lengths to generate majority minority districts. Absent proactive steps on the part of mapmakers, a minority population would be denied the ability to elect “the minority's preferred candidate”, Thornburg v. Gingles, 478 U.S. 30 (1986), in the states analyzed.

The present technology is not limited to redistricting application. Rather, the technology provides a graph partition wherein the data to be partitioned represents a geographic map, i.e., a set of spatial data with at least one geographic constraint. The partitioning seeks to define a set of contiguous and disjoint regions of the map, though both the disjoint constraint and contiguity constraint may be relaxed in some circumstances, without defeating the generality of the technology. Because the graph partitioning problem is “hard”, i.e., at large scale becomes infeasible, various heuristics or simplifications of the problem are employed. In the case of the redistricting problem, one simplifying presumption is the use of block-level data, rather than individual level assignments. Another simplification is a degree of error/deviation tolerance, e.g., slight variations in the number of persons per district. Another presumption is that the various solutions may be considered statistically independent, so that a set of possible solutions may be statistically processed to determine properties.

In some cases, the maps produced are not statistically independent. For example, correlated initial conditions for the partitioning may lead to a correlation of outcomes. This does not defeat the use of the graphs, but does diminish the statistical value of trying to compare an exemplar to a statistical compilation of a number of automatically generated graphs.

Because the algorithm defines a feasible set of partitions, it can run quickly, and therefore explore portions of the vast theoretical solution space. If one makes a presumption of a continuous function defining the underlying data and that small differences in boundary have an incremental effect on outcome, then the search of the solution space can define a minimal difference between graphs, and thus distribute the generated graphs across the possible options. In the case of redistricting, in a close race, the small differences may indeed be significant, but in other geographic partitioning applications, such differences may be insignificant. For example, a franchise may seek to drive business to various franchisees through a direct mail campaign by ZIP+4 regional codes. In this case, whether a household receives a coupon for one of various franchise locations which each meet an underlying constraint, e.g., distance, time-of-travel, geopolitical boundary, etc., may not be meaningful.

This technology can also be applied to non-geographic applications. For example, other problems may be expressed as graphs with distances and map-like constraints. On the other hand, the technology may be applied to more complex issues wherein geographic map issues are one of many issues. For example, in a dating, meeting, or social network environment, the matching of people may be dependent on geographic distance, travel time, geopolitical boundaries, etc. However, such systems may have a much higher dependence on other factors, such that physical location is not an over-riding concern. This may be expressed by increasing the dimensionality of the problem, and then partitioning in the hyperspace. Further, the increased-dimensionality problem may then be back-projected into a synthetic lower dimensionality space, for example using a clustering algorithm, such as k-means, according to a distance function. That is, the map to be partitioned may be a synthetic map that reflects multiple criteria, with various levels of statistical or logical processing, but prior to partitioning. The partitioning process, therefore, is relatively agnostic as to any physical correlates of the map constraints.

The constraints may be reflected in the partitioning algorithm as restrictions or hard rules, or as barriers having a weight or cost function. For example, in a redistricting application, there may be a preference to respect existing geopolitical boundaries. This may be reflected as a cost for breaching the boundary. A map region that respects a respective geopolitical boundary may have a lower “cost” than one which breaches the boundary, and so the corresponding advantage/benefit of the breach must exceed the cost. The cost, in this case, may be an arbitrary predetermined cost, a cost defined by an economic cost function which is dependent on externalities or a market process, an internally competitive process between partitions, or the like. For example, assuming the goal is to intentionally gerrymander a district to achieve minority power, a cost function may be employed which weights different political races/positions, which may each have different electoral characteristics. Thus, a district beneficial for a gubernatorial race may be disadvantageous for the comptroller race.

The technology may further be used to define transportation/delivery routes. For example, defining delivery truck routes and schedules. In this case, the contiguity requirement may be relaxed, though typically only one delivery vehicle would service any one region, and that same vehicle needs to have an efficient travel path throughout the route. This travel route then becomes an aspect of the “cost function” which drives compact routes. Further, traffic risks may impose costs (even if not present at all times) that force compactness. In this case, the presence of highways may be represented in a graph as hyperlinks, so that the regions, though geographically disconnected, are logically linked.

It is therefore an object to provide a system and method for partitioning a data set, mapped within a space, the space having regional features, according to a set of partitioning rules or constraints, wherein respective partitions within the space are disjoint, such that members of the data set are allocated to a respective partition to the exclusion of being allocated to a different partition, and assessing a quality of the partitioning according to at least one criteria distinct from the set of partitioning rules or constraints. The at least one criteria distinct from the set of partitioning rules or constraints may be used for ranking, or statistical validation, for example.

It is another object to provide a system and method for partitioning a data set representing a geophysical map having map features, according to partitioning criteria, to produce a plurality of disjoint partitions, using an iterative process from an initial condition, until the partitions meet a partitioning constraint; the process being repeated to produce a plurality of different maps which each meet the partitioning constraint; and assessing the plurality of maps according to at least one fitness criteria. The assessment may be a comparison of respective maps, or a statistical aggregation of a plurality of maps to determine a statistical map metric.

The method employs a series of steps, which may include: Transforming the data set into a series of smaller graphs; Partitioning the smaller graphs into a set of partitions according to at least one partitioning criterion using an iterative process; Inverting the transforming of the data into the set of smaller graphs, to project partitioned data back into the original data space; Refining the projected partitioned data according to the at least one partitioning criterion; and Testing the refined projected partitioned data.

According to graph theory, each node and each vertex may be assigned a weigh, which may be a predetermined value, normalized, adaptive, subject to externalities or temporal variation, a statistical value or distribution, a vector or tensor, a cost function, a value function, a cost-benefit function, etc. The weights may be independent or interactive based on a state of the partitioning.

A random seed, pseudorandom number generator, genetic algorithm, or the like, may be used to set the initial values for the transforming, partitioning, inverting, and/or refining, to yield different graphs. The graphs may be tested for distinctness. At intermediate stages of the process, convergence with a prior map may be thwarted by forcing a different decision or process flow than a prior generated map, on a local and/or global basis.

It is therefore an object to provide a method of partitioning a map into a plurality of disjoint regions each representing a respective continuous bounded geographic region, comprising: receiving a data set representing a map, comprising a geographic region having geographic variations, and population data associated with respective locations in the geographic region; defining at least one partitioning objective; successively processing the data according to an initial condition, to partition the geographic region into a plurality of districts which meet the at least one partitioning objective, according to a plurality of respectively different initial conditions, to produce a plurality of district maps, each dependent on at least the geographic variations and the initial conditions; analyzing the plurality of partitioned geographic regions according to at least one criterion, selectively responsive to a population statistic of the population data associated with each district within the geographic region; and determining aggregate statistical properties of the plurality of district maps.

The method may further comprise receiving a second map, comprising the geographic region having the geographic variations, partitioned into a plurality of districts, and determining a statistical relationship of the second map to the aggregate statistical properties of the plurality of district maps.

The at least one criterion may comprise a human voting profile associated with the population data.

The population data may comprise census data, and the human voting profile comprises historical election voting patterns.

The defining step may perform a multi-criterion optimization comprising population equality, district compactness, and conformity with geographic features of the geographic region, and the aggregate statistical properties relate to electoral voting propensity.

It is also an object to provide a method for partitioning a data set, representing a population geographically mapped within a space, the space having regional features, comprising: receiving the data set, characteristics of the regional features, and characteristics of the population; defining a set of partitioning rules or constraints; partitioning data set, to define a set of continuously-bounded subspaces based on at least the data set, the characteristics of the regional features, and the set of partitioning rules or constraints, wherein respective partitions of the data set are disjoint, such that members of the population are allocated to a respective partition to the exclusion of being allocated to a different partition; and assessing a quality of the partitioning according to at least one population statistic selectively dependent on the respective characterization of the population, and allocation of members of the population to respective subspaces.

The method may further comprise performing said partitioning of the data set a plurality of times, under a plurality of different initial conditions, to produce a plurality of alternate partitioned data sets; and determining statistical properties of the respective quality of the plurality of alternate partitioned data sets.

A plurality of different partitionings of the data set may be ranked.

The method may further comprise producing a statistical aggregate of a plurality of different partitions of the data set.

The method may further comprise performing said partitioning of the data set a plurality of times, under a plurality of different initial conditions, to produce a plurality of alternate partitioned data sets; and statistically comparing the plurality of alternate partitioned data sets with an independently defined partitioning of the data set.

The statistical comparison may comprise determining a likelihood of gerrymandering of the independently defined partitioning of the data set.

The partitioned data set may be biased or unbiased. The bias may be introduced in the set of partitioning rules or constraints, or otherwise. The bias may be intentionally introduced to remediate preexisting conditions. The set of partitioning rules or constraints may be defined to optimize a voting efficiency of the population in the partitioned data set. The assessing may determine an optimality of a voting efficiency of the population in the partitioned data set.

It is a further object to provide a computer readable medium storing non-transitory instructions for causing a programmable processor to perform a method for partitioning a data set representing a map having map location features and associated population features of a population located with respect to the location features, according to at least one partitioning criterion, the non-transitory instructions comprising: instructions for defining a respective initial condition for a partitioning; instructions for partitioning the data set to produce a plurality of spatially-contiguous partitions of the map, based on at least the data set and the map features, dependent on the initial condition, to produce a plurality of disjoint partitions which meet the at least one partitioning criterion; instructions for repeating the partitioning according to different respective initial conditions, to yield a plurality of different partitioned data sets; and instructions for statistically assessing the plurality of different partitioned data sets with respect to the population features.

The computer readable medium may further comprise: instructions for transforming the map into a series of graphs each smaller than the map; instructions for partitioning the series of graphs into a set of partitions according to the at least one partitioning criterion and the respective initial condition; instructions for inverting said transforming, to project the partitioned map data back to the map; instructions for refining the projected partitioned map data according to the at least one partitioning criterion; and instructions for testing the refined projected partitioned map data for fitness.

The computer readable medium may further comprise instructions for determining a statistical relationship of population features of a partitioned second map having the map features, to aggregate statistical properties of a plurality of partitioned data sets.

The instructions for partitioning the data set may perform a multi-criterion optimization comprising population equality, district compactness, and conformity with the map features, and the statistically assessing relates to electoral voting propensity of the population located within respective partitions of the partitioned data set. The voting propensity may be predicted based on historical election voting patterns and census data.

### BRIEF DESCRIPTION OF THE DRAWINGS

FIGS. 1A-1F shows an example of sequential steps of how the algorithm partitions a map consisting of nineteen contiguous geographic units.

FIG. 2 shows a plot of centroids for 10,000 two-way partitions of a 100×100 grid of geographic units with equal population. If the algorithm draws uniformly from the distribution of all possible districts, horizontally oriented districts (like examples A and C) should be as likely as a vertically oriented districts (like examples B and D). The location of the darker district's centroid in the plot is noted with a lighter “+” symbol.

FIG. 3A shows the manner in which the algorithm scales with the number of districts (D) and the number of geographic units (n).

FIG. 3B shows a comparison of algorithmic complexity of the present algorithm to the algorithm proposed by Cirincione et al. (2000). The x-axis in both graphs represents the number of geographic units (n) that the algorithm takes as an input, and the y-axis represents the number of districts (D) that the algorithm creates from those geographic units. The lines represent orders of magnitude in diff in asymptotic runtime at corresponding values of D and n.

FIGS. 4A-4D show the actual and three neutral maps of Mississippi exhibit the types of variation typical of the neutral mapping algorithm.

FIG. 5A-5D show the actual and three neutral maps of Virginia exhibit the types of variation typical of the neutral mapping algorithm.

FIG. 6A-6D show the actual and three neutral maps of Texas exhibit the types of variation typical of the neutral mapping algorithm.

FIGS. 7A-7C show the actual map and simulated maps of Wisconsin.

FIGS. 7D and 7E show first and second example neutral maps of Wisconsin.

FIGS. 8A and 8B show median-mode analysis of districts in Wisconsin for various state-wide elections.

FIG. 9 shows a bias of districts in Wisconsin.

FIG. 10 shows a graph of the efficiency gap and median-mean for various Wisconsin state-wide elections.

FIG. 11 shows a graph of the efficiency gap and media-mean for the 2014 election.

FIG. 12 shows the density of media-mean comparison in 10,000 neutral maps (vertical line is the observed media-mean in current districts).

FIG. 13 shows the density of the efficiency gap on 10,000 neutral maps (dashed vertical lines is the observed median-mean in current districts; dashed line is the 8% gerrymandering threshold).

FIG. 14 shows a graph of the efficiency gap in one district with 100 voters.

FIG. 15 shows a software flowchart.

### DETAILED DESCRIPTION OF THE PREFERRED EMBODIMENTS

A Graph Partitioning Approach to Redistricting

A method is provided for estimating the distribution of possible maps using a graph partitioning approach. An algorithm is used for sampling possible redistricting plans. The algorithm is demonstrated to work on a simple redistricting problem consisting of nineteen geographic units and two legislative districts.

Graph Partitioning as a Solution to the Redistricting Problem

Framing redistricting as a graph partitioning problem allows simplification of the process of drawing maps. As a result, a set of neutral maps of legislative districts may be generated under the constitutional constraints that districts be contiguous and contain equal populations. A map may be conceived as an undirected vertex-weighted graph in which vertices are weighted according to population, but edges are assigned no meaningful weight. Discussion focuses on vertex weighted graphs, but the class of graph partitioning algorithms applied to the problem of redistricting can account for weights applied to edges between vertexes, and other factors. By incorporating additional information about the relationship between vertexes (geographic units), additional constraints may be addressed that states place on the types of legislative maps they produce.

The approach can be summed up as follows: First, the geographic data is converted into a graph, where every geographic unit becomes a vertex weighted by the population of the geographic unit. The graph's edges represent shared borders between geographic units. The graph is then partitioned (a simpler version of the graph derived from the map) into the required number of districts that meet the legal requirements of being both contiguous and containing equal population. Since it is often infeasible to have districts that are exactly balanced, the algorithm is satisfied by districts with populations that neither exceed nor fall below certain bounds.

An Algorithm for Drawing Neutral Districts

The algorithm for achieving a contiguous and balanced partition has four steps. Vertices are weighted by population. If the districts produced by the algorithm are balanced (of equal weight), they also have equal population in this application of the algorithm.

First, the algorithm coarsens the graph, grouping together connected vertices of the graph into contiguous multinodes. Second, the algorithm partitions the multinodes of this simplified graph into the desired number of contiguous districts using a breadth first search. Third, it uncoarsens the graph, so that the graph is again made up of the original vertices, but all vertices are now associated with a particular district from the previous step. Finally, it refines the graph by moving vertices into and out of districts until the populations of the districts are balanced. Refinement continues until either the established tolerances are met, or the graph ceases to become more balanced. In practice, the algorithm may produce imbalanced districts if the refinement process fails to produce a more balanced graph. In those instances, the algorithm fails to converge, and that simulated map is simply discarded and the process started with a new random seed. See, Pothen et al. (1997); Hendrickson et al. (1995); Karypis et al. (1999); Gupta (1997); Sanders et al. (2011); Koren et al. (2002); Hendrickson et al. (1995); Aykanat et al. (2008); Catalyurek et al. (2009); and Trifunovic et a. ((2004).

Consider a weighted graph G₀(A₀, E₀, w) where w is a function that maps A₀ onto a set of weights. Discussion is limited to the intuition behind the algorithm and a formal description of the process is also described below.

Step 1 (“Coarsening”)

G₀ is transformed into a series of smaller graphs G₁, G₂, G₃, . . . , Gₘ where vertices in Gₜ are consolidated into a multinodes in Gₜ₊₁. These multinodes are an intermediate construct that allow the algorithm to perform a more efficient partition, but they do not represent a politically meaningful unit. The number of multinodes is not particularly important, and neither do they have to be particularly balanced. The important thing is that they are internally contiguous, and that they are not too uneven. The algorithm will behave correctly if the multinodes are very uneven, but it will take longer to converge on a balanced graph in the last step of the algorithm, so this is a performance concern, but not a correctness issue.

In this case, since the graph has unweighted edges, the algorithm randomly selects an initial node. It is possible to assign weight to the connections (edges) between nodes. For the purpose of drawing neutral maps of contiguous, equipopulous districts, this information is not taken into account, though additional considerations may be included within the analysis.

The algorithm then selects vertices from among the neighbors of that vertex and joins those vertices into a multinode. The algorithm repeats this process until all vertices are assigned to one of several multinodes. The intention is to simplify the graph in order to simplify the problem of partitioning the graph. Critically, all the information of a multinode's constituent nodes, their connection to other vertices and their weight, is preserved when vertices are collected into multinodes. Thus one multinode is adjacent to another multinode if at least one constituent vertex in each are adjacent to one other. Likewise, the weight of a multinode is the sum of the weights of its constituent nodes.

Step 2 (“Partitioning”)

Once the graph has been simplified, the algorithm generates partition Pₘ. It randomly selects a multinode with which to start. It then selects a neighboring multinode to add to the district and continues to add randomly selected neighbors until roughly 1/k of the available weight is in the district where k is the number of districts into which the vertices (multinodes) should be divided. This means that the algorithm begins by randomly adding multinodes that are contiguous to the multinode initially selected by the algorithm. If it exhausts all options among the vertices that are contiguous with the first nodes, it only adds multinodes that are contiguous to multinodes that are contiguous to the first multinodes, and so on. The algorithm discards discontiguous graphs that result when the process yields a set of multinodes that cannot be joined because they are separated by contiguous districts.

Step 3 (“Uncoarsening”)

In series of steps, the algorithm reverses the aggregating process that yielded Gₘ. At the beginning of each step t, the constituent elements of multinodes in Gₜ₋₁ preserve their assignment to a particular district in Pₜ₋₁.

Step 4 (“Refinement”)

Generally speaking, the purpose of this step is to make each component of a partition Pₜ as balanced as possible. At each step of uncoarsening the algorithm reassigns elements of one district into an adjacent district if reassignment would bring the districts closer to weight parity. This requires the implementation of an additional balancing algorithm to determine which elements of a partition should be (or should not be) reassigned. In practice, there exist several algorithms that can refine the graph into a more balanced partition. The Kernighan Lin algorithm (KL) (Hendrickson and Leland 1995; Kernighan and Lin 1970) is employed to refine the graph at each step of uncoarsening. KL is a widely used algorithm for balancing graphs in computer science since it accounts for the weights of vertices and edges as it seeks to produce a more balanced map. The edges between vertices are assume to have no weight; however, applications of the algorithm on graphs with weighted edges is a possible extension of the analysis presented below.

Step 5 (“Repeat”)

This step is the easiest of all, as it is just a check to see if the partition meets the required balance (population equality) conditions. If the resulting partition is a set of contiguous and balanced districts, the partition is recorded for later analysis. If not, the flawed partition is discarded and the algorithm restarts.

### An Example

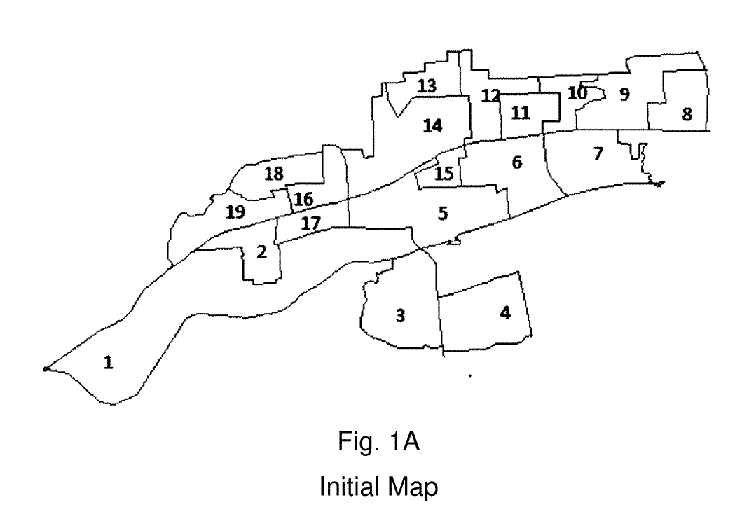

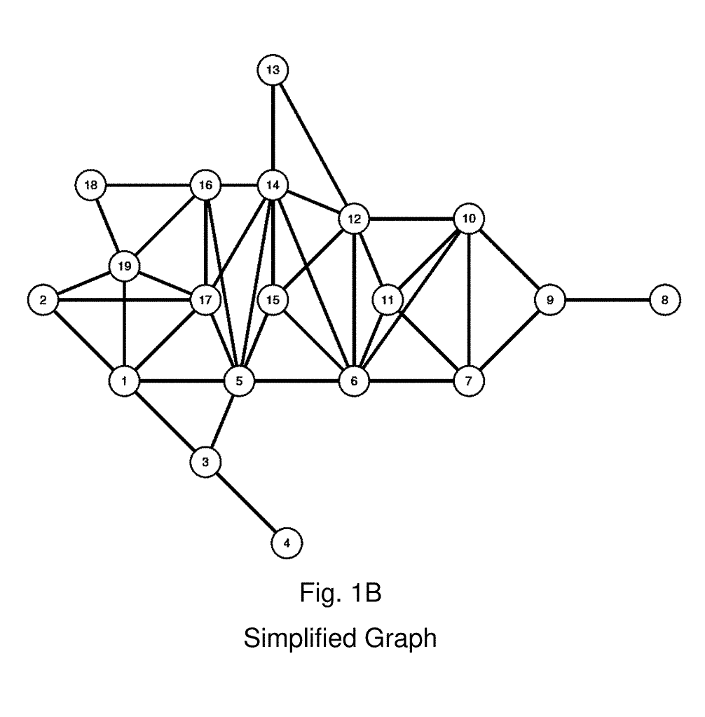

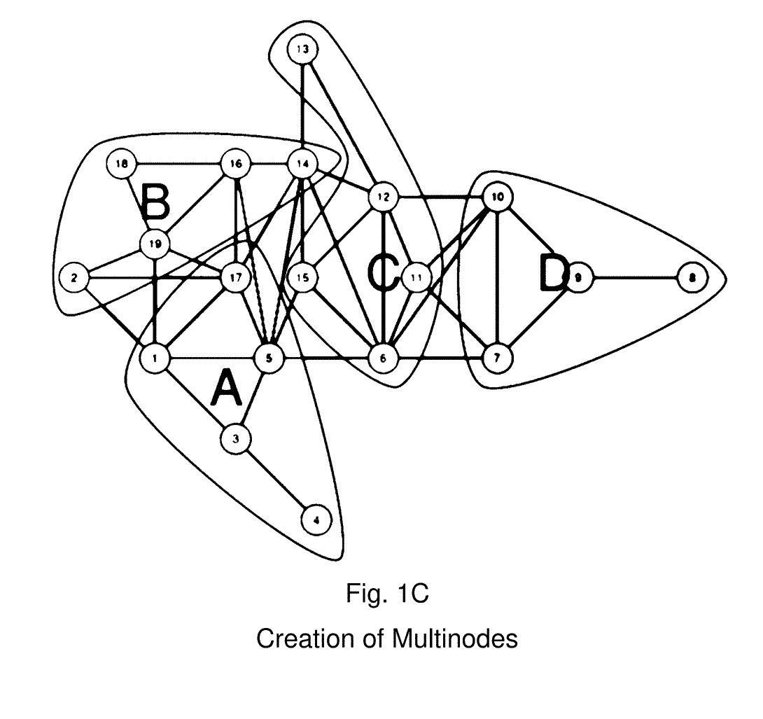

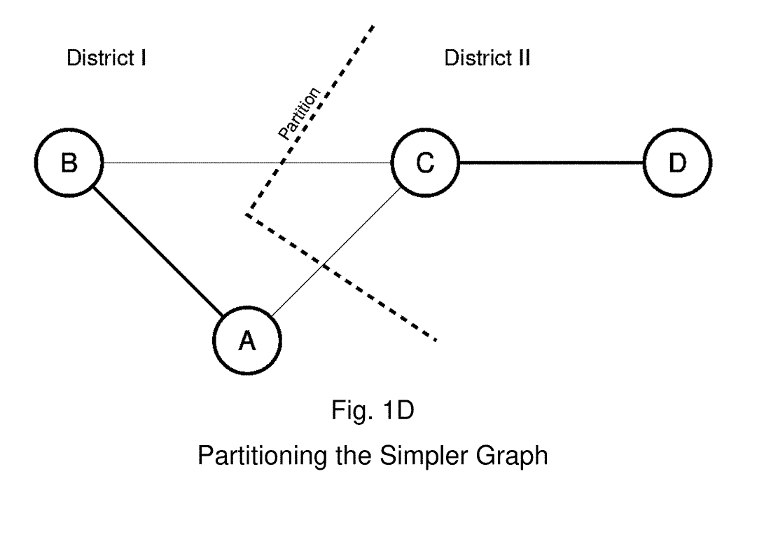

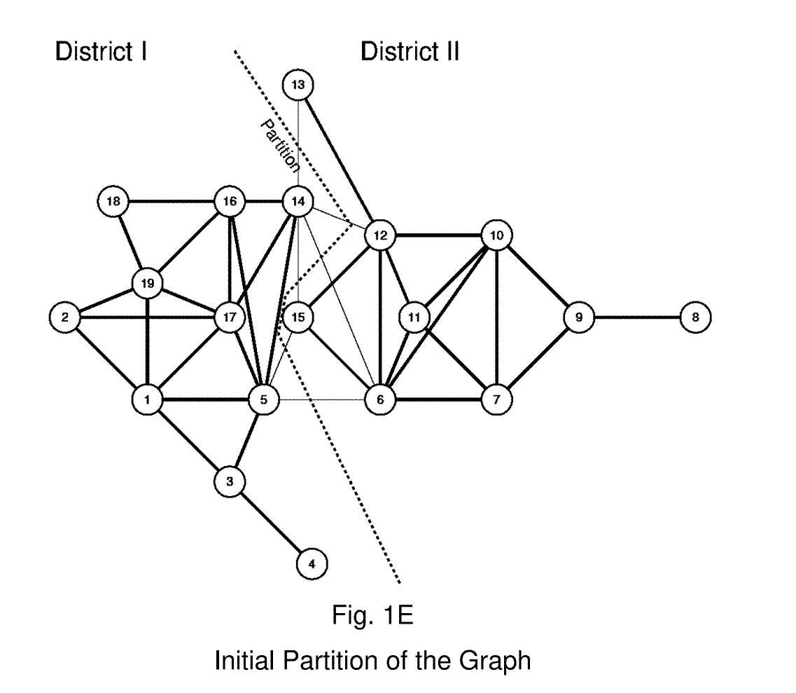

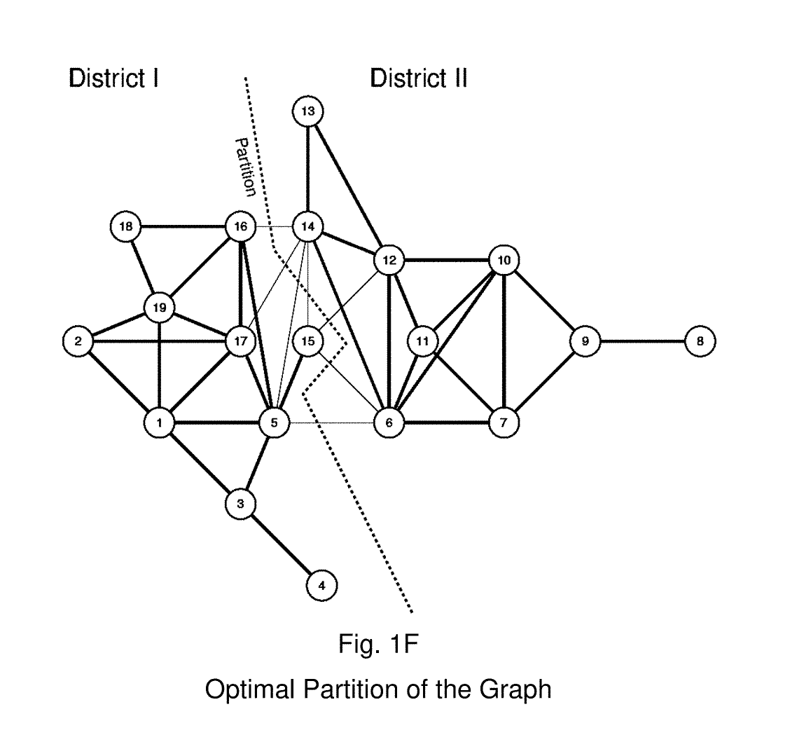

Consider a simple application of the method of drawing legislative districts to a set of nineteen contiguous geographic units represented in FIG. 1A. The goal is to partition this map into a plan with two contiguous districts in which the population of both districts is balanced. The set of geographic units represented in FIG. 1A is globally contiguous—that is, every unit in the map could potentially be included in a contiguous district with any other unit in the map. The algorithm proceeds by, first simplifying the map into a connected graph with nineteen vertices and thirty-nine edges; second, collecting vertices into an even simpler graph; third, partitioning the simpler graph; and finally, refining the graph to ensure that the resulting districts have balanced (equal) populations. In this example, the result of this process is a single “partition” of the map into a set of two districts with equal populations.

First, the algorithm begins by simplifying the map into a connected graph. Using the map in FIG. 1A, it is determined which geographic units share any portion of its border with any other geographic unit. This variety of contiguity is sometimes called “Queen Contiguity” in reference the directions players may move the queen in a game of chess. Queen Contiguity contrasts with “Rook Contiguity” in that units need only share a point of contiguity in order to be considered contiguous.

The simplified graph of the map is represented in FIG. 1B. Each geographic unit is represented as a circular node. An edge (line) connects the vertex representing a unit to the vertex representing other units with which it is contiguous. In this simplified version of the original map, there are nineteen vertices connected by thirty-nine edges. This representation of the map preserves all of the information necessary for generating contiguous districts.

Second, the algorithm randomly collects vertices into multinodes creating a simpler graph. In the example, the algorithm assigns groups of four or five vertices to one of four multinodes. This process is represented in FIG. 1C. Each of the vertices assigned to a multinode shares an edge with at least one vertex in the multinode making each multinode internally contiguous.

These multinodes are indexed as A, B, C, and D. The process of collecting these vertices into multinodes is random, so in any iteration of the algorithm, it is expected that two neighboring vertices will end up in different multinodes with positive probability. Observe that if two multinodes have constituent vertices that were contiguous in FIG. 1B, those multinodes are contiguous in FIG. 1C. That is, the multinodes preserve the contiguity of their constituent nodes.

Third, the algorithm partitions the simpler graph. It assigns each multinode (and the multinode's constituent nodes) to a district. This process is represented in FIG. 1D. Here, the algorithm generates the partition {A, B}, {C, D}. Note that not all combinations of these multinodes would be valid. While A, B, and C are all contiguous, the vertices in D are only contiguous with vertices C.

Finally, the algorithm refines the graph in order to ensure that the resulting districts have balanced (equal) population. The graph partitioning problem represented in FIG. 1D is significantly simpler than the problem of finding a valid partition of the graph in FIG. 1B with nineteen nodes, but this comes at the cost of balance. Since the multinodes were generated randomly, the partition represented in FIG. 1D is not likely to be balanced. The process of refining the partitioned graph is represented in FIGS. 1E and 1F.

Kerhighan-Lin swaps randomly selected vertices across the border generating an alternative partition. If the alternative partition is closer to being balanced than the initial partition, it keeps the alternative and throws out the initial partition. It stops once switching vertices does not generate a more balance graph.

This example is limited to the generation of a single partition of the map in FIG. 1A; however, analysis of observed maps requires comparison of those maps to a neutral counterfactual. Since the process of creating multinodes began with the random selection of a vertex to which adjacent vertices were added, each time the algorithm is repeated in a large enough graph, an alternative, balanced partition with positive probability is arrived at. Since the algorithm only considers the contiguity and weight (population) of each node, the result is a distribution of neutrally drawn districts. The algorithm is not constrained to generate maps with compact districts although the Supreme Court has expressed a preference for maps with this feature (See Shaw v. Reno, 509 U.S. 630 (1993); Miller v. Johnson, 515 U.S. 900 (1995)). As it turns out, districts generated by the present technology seem to avoid the most extreme varieties of non-compactness in empirical applications.

The actual set of legislative districts may then be compared to the distribution of districts observed, and the probability that the actual partition created would have emerged from a neutral process characterized.

Bias and Efficiency

The algorithm described above avoids many of the shortcomings of alternative algorithms. Specifically, no evidence of bias is found in the way the algorithm draws districts. Two tests for bias are employed. The first test is designed to reveal if the algorithm produces districts of one variety more often than districts of another variety. It does not. The second test is designed to evaluate the algorithm's ability to retrieve an approximation of the underlying distribution of possible districts. A large sample of maps drawn by the algorithm is compared to a known distribution of possible districts. The distribution of maps the algorithm retrieves is found to be very similar to the known distribution.

The algorithm is remarkably efficient. Using asymptotic analysis, a technique used by computer scientists to evaluate the complexity of algorithms, the algorithm is compared to a commonly used alternative proposed by Cirincione, Darling and O'Rourke (2000). The algorithm is many orders of magnitude more efficient than the alternative approach.

Bias

In order to evaluate the possibility that our algorithm draws maps in a biased way, the algorithm for drawing districts is applied to a problem for which the solution is known (Altman, Gill and McDonald 2004). First, to show that the algorithm is does not produce districts of one variety more often than districts of another variety, the algorithm is applied to a square (100×100) geographic space with 10,000 units, all of which contain the same number of people and evaluate the resulting maps to see if one type of district is more likely than others. No such result is found. Second, to evaluate the algorithm's ability to approximate the underlying distribution of possible districts, the algorithm is applied to a much simpler space, for which the true distribution of possible districts is known. In this case, the algorithm approximates the true distribution.

Bisecting a Symmetrical Space

Demonstrating bias in a sample from a distribution as large and complex as the set of possible electoral maps is complicated proposition. In practice, the geographic units that constitute the basis of jurisdictions' electoral maps have irregular populations and have varying numbers of neighbors to which they are adjacent. One way to approach the problem is to consider a case for which the characteristics of an unbiased sample are known. In this instance, a hypothetical symmetrical set of geographic units is partitioned with equal population. Since it is identical vertically and horizontally, the number of maps that bisect the space horizontally should be observed to be close to equal to the number of maps that bisect the space vertically. Altman et al. (2015) propose a similar test using a smaller grid, and they find that several commonly used redistricting algorithms are more likely to produce one type of map than another. The test is implemented on a large grid containing roughly the number of units in a medium-sized state's map of electoral precincts. Such a test has substantive implications. For example, consider jurisdictions with geographically segregated racial populations like Detroit, Mich. Historically, neighborhoods north of a particular street (8 Mile Road) are predominantly white. For decades, neighborhoods to the south 8 Mile Road have been predominantly black. A sample taken by an algorithm that is more likely to partition Detroit and its suburbs vertically (north to south) or horizontally (east to west) is going to misrepresent the number of majority black districts in the underlying set of possible districts.

Consider a square geographic space with 10,000 units that each contain the same number of residents. For simplicity, suppose that there are two possible outcomes of the process: districts that bisect the space horizontally and districts that bisect the space vertically. Observe that such a space is symmetrical vertically and horizontally. If the goal is to divide such a space into two districts with equal population, an unbiased process should be as likely to bisect the space horizontally as it is to bisect the space vertically. The algorithm is applied to this simple problem. First, a grid of 100×100 (10,000) units is partitioned 1 million times (Magleby and Mosesson 2017). Next, the number of districts that bisect the space horizontally, how many bisect the grid vertically, is determined.

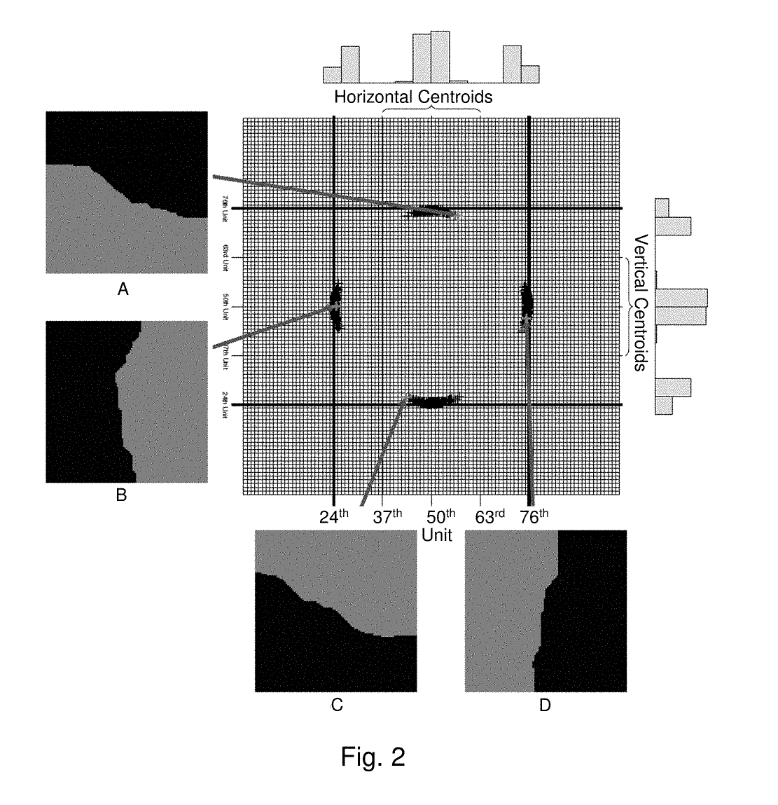

In FIG. 2, the centroid of one district from 1000 two district maps produced by the algorithm from the hypothetical grid is plotted. Examples A, B, C, and D in FIG. 2 represent the types of bisections the algorithm produces. Each bisection has a darker and lighter “district,” and with arrows pointing to the location of the darker district's centroid on the example grid. Above the plot, a histogram representing the density of observed centroids on the x-axis is provided. To the right of the plot, a histogram of the density of observations on the y-axis is provided. While not identical, these distributions are very similar for the 1,000 observations by visual examination. All centroids fall between the 24th and 76th units on the x-axis and y-axis.

To identify horizontally and vertically oriented plans, the range of centroids on each dimension is divided into three regions. Districts with centroids between the 37^{th} and the 63^{rd} unit on the on the x-axis are considered to be horizontal. In like manner, districts with centroids between the 37^{th} and the 63^{rd} unit on the y-axis are considered to be vertical. If the algorithm produces maps in an unbiased way, then half the maps should have districts with centroids in the vertical region and half the maps should have districts with centroids in the horizontal region.

In 1 million trials, 500,644 maps were found have a vertical orientation (a centroid in the region between the 37th and the 63rd unit on the y-axis) and 499,356 have a horizontal orientation (centroid in the region between the 37th and the 63rd unit on the x-axis). The resulting proportion of maps with vertically oriented districts (0.500644) is not statistically different from 0.5, the expected result from an unbiased process (χ²=1.659, p=0.1977). Thus, no statistically significant evidence of bias is found in the orientation of the 1 million maps created by the algorithm. In addition, only a small substantive difference (0.0006) from what is expected in an unbiased mapmaking process is observed.

Sampling From A Known Distribution

The algorithm is applied to a small jurisdiction consisting of twenty-five geographic units made available by Fifield et al. (2015). The algorithm is set to partition the space into three districts with populations that deviate by no more than 10% from population parity (Magleby and Mosesson 2017). Then, the distribution of maps produced by our algorithm is compared to the distribution of all possible maps of the jurisdiction provided by Fifield et al. (2015). A Kolmogorov-Smirnov test indicates that the two distributions are not exactly the same; however, the distribution of maps retrieved by the process approximates the true distribution enumerated by Fifield et al. for maps balanced to 10% population parity. The KS statistic may not be an appropriate measure for the comparisons between these distributions. For example, KS does not deal with ties, the estimated p-values cannot be assured to be exact. Similarly, the test presumes that the underlying distributions of possible maps are continuous. Given that Fifield et al. enumerate all of the possible maps, and the number of possible maps is relatively small (extremely small in the case of the more balanced maps), the distributions do not satisfy the test's assumption of continuity. On the other hand, when the analysis is constrained to maps that meet more standard levels of population parity (±1.5%), a KS test does not permit us reject the null hypothesis of equivalence between the distribution of possible balanced maps and the distribution of balanced maps drawn by the algorithm.

To summarize the maps' characteristics, the level of partisan skew in each map is focused on, specifically the skew in the distribution of Democratic votes across districts in a map. To find a map's skew, the proportion of votes cast for Democrats in each of the three districts is calculated, then the map's mean district-level Democratic vote proportion subtracted from the map's median district-level Democratic vote proportion. If the difference is negative (positive), Democratic (Republican) votes were over-concentrated in one or two districts in the map. If the difference is 0, the Democrats are neither advantaged or disadvantaged by the lines drawn by the algorithm. This is the measure proposed by McDonald and Best (2015) for detecting packing gerrymanders. Determining the level of partisan skew in a map is also one element of Wang's three pronged test for evaluating partisan gerrymandering (2016).

Partisan skew in the set of possible maps, as reported by Fifield et al. (2015), balanced to ±10% to a set of maps drawn using the technology also balanced to ±10% is considered. In Table 1, four characteristics of the true distribution of partisan skew are compared with the same four characteristics of the distribution of partisan skew of the maps drawn by the algorithm. While characteristics of the distribution of maps produced by the algorithm approximates the characteristics of the distribution possible maps, the distributions are not exactly equivalent. In Table 1, the Kolmogorov-Smirnov (KS) statistic is included for the comparison between the distribution recovered by the algorithm and the true distribution as reported by Fifield et al. (2015). The KS test yields a test statistic of 0.241. Thus, the null hypothesis, that the distribution of maps produced by the algorithm is the same as the distribution enumerated by Fifield et al. (2015) can be rejected.

Important caveats apply to the comparisons summarized in Table 1. First, the KS test indicates that the two distributions are not identical; however, this finding should not be construed to mean that the sample of maps created by the algorithm does not approximate the distribution of all possible maps. The two distributions are very similar, are not claimed to be equivalent. Second, the set of maps enumerated by Fifield et al. (2015) is not particularly balanced, that is, the population deviation between the largest and smallest districts in the set of possible maps is relatively large (±10%). (This level of imbalance is close to violating constitutional constraints on population parity.) In the bottom panel of Table 1, the characteristics of the set of maps in Fifield et al.'s data that are balanced to a more typical level of population deviation (±1.5%) are presented. Summary statistics from the subset of maps produced by the present algorithm, that conforms to the more typical population constraint (336/20,000=0.016) is also presented. The comparison is informative in that it shows how few of the possible maps in Fifield et al.'s data achieve standard levels of population parity (6/927=0.006). As with the larger sets of maps, the distributions of maps approximate one another. In contrast to the comparison between the larger sets of maps, the KS test does not show a significant difference between the set of possible maps with population parity and the set of subset of maps produced by the algorithm with population parity (p=0.2092). In sum, the KS test does not permit rejection of the null hypothesis of equivalence between the distribution of possible balanced maps and the distribution of balanced maps drawn by the present algorithm.

TABLE 1

| | True | Proposed |
|---|---|---|
| | Distribution | Algorithm |
| Maps balanced to ±10% | | |
| Mean | 0.003 | 0.009 |
| Median | 0.009 | 0.011 |
| Standard Deviation | 0.020 | 0.018 |
| Kurtosis | 3.665 | 2.027 |
| N | 927 | 20,000 |
| Kolmogorov-Smirnov | D = 0.24072 | p < 0.001 |
| Comparison of distributions | | |
| Subset of maps | | |
| balanced to ±1.5% | | |
| Mean | −0.004 | 0.004 |
| Median | −0.010 | 0.009 |
| Standard Deviation | 0.015 | 0.009 |
| Kurtosis | 1.727 | 2.661 |
| N | 6 | 336 |
| Kolmogorov-Smirnov | D = 0.4375 | p = 0.2092 |
| Comparison of Distributions | | |

Table 1 shows a comparison of the mean, median, standard deviation, and kurtosis of the true distribution of partisan skew of all possible maps containing districts that deviate by no more than 10% (N=927) to the distribution of maps drawn by the algorithm, that in which the district population deviates by no more than 10% (N=20,000). The mean, median, standard deviation, and kurtosis of all possible maps containing districts that deviate by no more than 1.5% (N=6) are compared to the distribution of maps drawn by the algorithm, in which the district population deviates by no more than 1.5% (N=336).

TABLE 2

| | True | Proposed |
|---|---|---|
| | Distribution | Algorithm |
| Maps balanced to ±10% | | |
| Mean | 0.003 | 0.009 |
| Median | 0.009 | 0.011 |
| Standard Deviation | 0.020 | 0.016 |
| Kurtosis | 3.665 | 3.598 |
| N | 927 | 40,000 |
| Kolmogorov-Smirnov | D = 0.1587 | p < 0.001 |
| Comparison of distributions | | |
| Subset of maps | | |
| balanced to ±1.5% | | |
| Mean | −0.004 | 0.006 |
| Median | −0.010 | 0.009 |
| Standard Deviation | 0.015 | 0.007 |
| Kurtosis | 1.727 | 6.378 |
| N | 6 | 1691 |
| Kolmogorov-Smirnov | D = 0.5454 | p = 0.057 |
| Comparison of Distributions | | |

Table 2 is similar to Table 1, but reports results for larger N (N=40,000 for maps balanced to ±10%, and N=1691 for maps balanced to ±1.5%). The Kolmogorov-Smirnov (KS) statistic is included for the comparison between the distribution recovered by the proposed algorithm and the true distribution as reported by Fifield et al. (2015b). The KS test yields a test statistic of 0.1587. Thus, we can reject the null hypothesis that the distribution of maps produced by the algorithm is exactly the same as the distribution enumerated by Fifield et al. (2015b). However, the KS test does not permit us reject the null hypothesis of equivalence between the distribution of possible balanced maps and the distribution of balanced maps drawn by the proposed algorithm.

Efficiency

In addition to showing no indication of bias, the algorithm is extremely efficient. This is demonstrated by considering its algorithmic complexity, and showing how that complexity scales with the complexity of the redistricting problem. Once the algorithmic complexity of the process is understood, it is possible to contrast the algorithm to the process proposed by Cirincione, Darling and O'Rourke (2000), a commonly used alternative. While other automated redistricting processes exist, Cirincione, Darling and O'Rourke's process is a useful comparison because it is acknowledged to be the “representative” redistricting algorithm (see Altman et al. 2015; Fifield et al. 2016). In their widely used BARD package for R, Altman and McDonald (2011) implemented Cirincione, Darling and O'Rourke (2000) making it one of the most widely used algorithms for the purposes of automated redistricting. For practically all redistricting problems, the algorithm should outperform the commonly used alternative.

An asymptotic analysis of the algorithm characterizes its algorithmic complexity and demonstrates how that complexity scales with the complexity of the redistricting problem. The algorithm may be conceived as a function that maps some number of geographic units, n, into some number, D, of contiguous electoral districts. By analyzing the asymptotic behavior of the function that describes the algorithm, the way that processing time will increase as the redistricting problem becomes more complex, holding computational resources constant, may be determined. The redistricting problem becomes more complex as either n or D or both increase. The algorithm scales according to the following function:

f(n,D)=n² log nD log D (1)

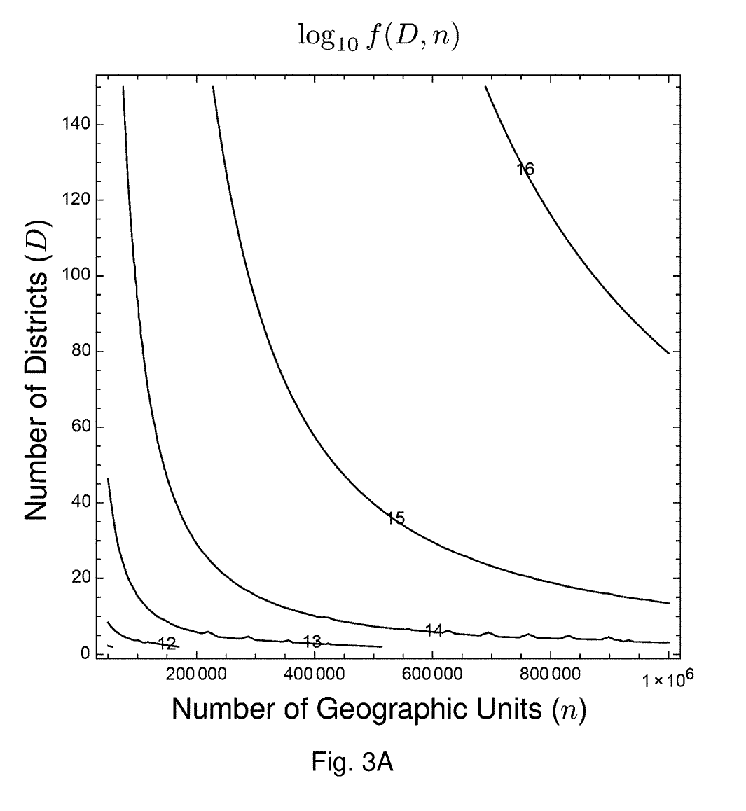

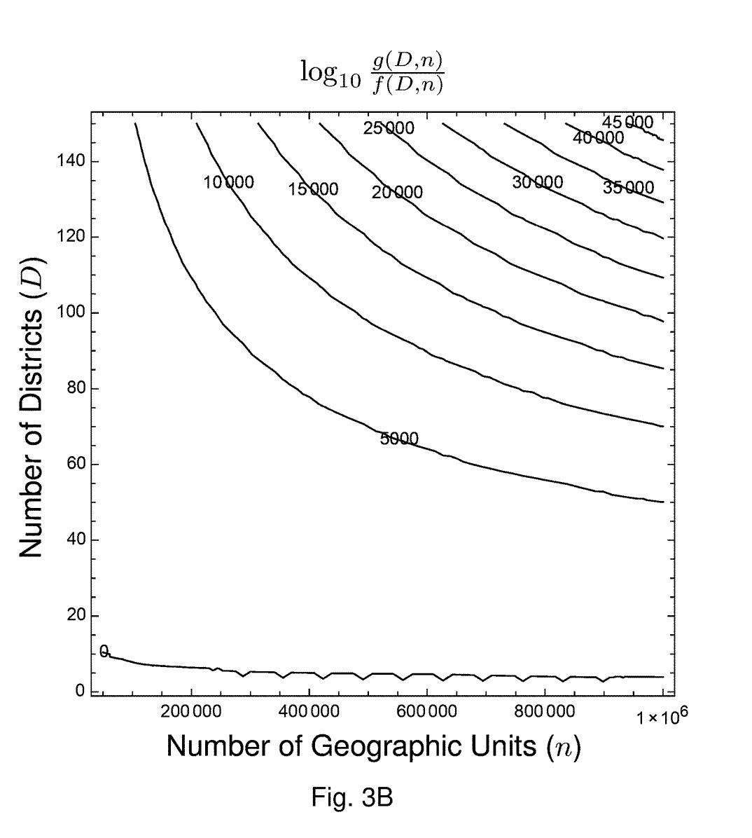

The contour plot in FIG. 3A represents the way that (1) scales for different values n (x-axis) and D (y-axis). Each line represents the log₁₀ of constant runtime. For example, as shown in the graph, the algorithm should take the same amount of time to divide 100,000 units into 120 districts as it would take to divide 600,000 units into ten districts. The absolute value of the numbers associate with each contour line are less important than the relative increase. The graph indicates that, holding D constant, the algorithm's runtime increases in n. The same is true in reverse: holding n constant, the marginal impact on expected runtime increases with each additional district. Take the case of a state legislature with 100 members of its lower house. Our asymptotic analysis suggests that if it took 0.01 seconds to draw a map of 100 districts from roughly 100,000 geographic units, it would take about 0.1 second to draw a map of 100 districts from roughly 300,000 geographic units, and it would take 1.0 seconds to draw a map of 100 districts from 850,000 geographic units.

The computational efficiency of the algorithm becomes particularly important when compared to other algorithms devised to address the same redistricting problem. For example, take a commonly used alternative redistricting algorithm proposed by Cirincione, Darling and O'Rourke (2000). Their algorithm scales according to the following function:

$$h ( n , D ) = \frac{n}{{\prod }_{1}^{D - 1} p ( n , i )} \qquad ( 2 )$$

Where p(n,i) is the probability that the next iteration will successfully yield a contiguous district. Since the Cirincione, Darling and O'Rourke (2000) algorithm draws districts iteratively, the function h(n,D) also includes a probability function p(n,i) that the next iteration will successfully yield a contiguous district. That probability decreases with each district the algorithm draws. For illustrative purposes it is assumed that the next district drawn by the algorithm will almost certainly be contiguous (p(n,i)=0.99999).

The difference between (1) and (2) may not be immediately apparent, so the ratio of expected runtimes for values of n and D is represented in FIG. 3B. Here, the contour lines represent the difference in runtime (in orders of magnitude) between the algorithm and this commonly used alternative. Asymptotic properties of the algorithm in this type of analysis are of interest, and constants drop out of the assessment of complexity. Hence, if the algorithm discards 90% of its maps, or 99%, it has the same algorithmic complexity. By contrast, the rate of failure to find a valid map is proportional to the number of districts or vertices to which the Cirincione, Darling and O'Rourke (2000) algorithm might be applied. In other words, the number of maps discarded is constant in the present algorithm and is independent of the complexity of the redistricting problem, but the number of maps that would need to be discarded using Cirincione, Darling and O'Rourke (2000) is a function of the complexity of the redistricting problem.

The contour line labeled 0 are the values of n and D for which no difference in runtime is expected between the two algorithms. From FIG. 3B, it is clear that the present algorithm outperforms the alternative algorithm for all redistricting problems except those for which the n or D is very small.

The difference between the two algorithms is stark when either is applied to jurisdictions with larger n and more D. For example, consider the redistricting problem for New York's State Assembly. There are 150 Assembly districts in New York (D=150). In the United States, state legislatures pose the most complex redistricting problem because of the large number of districts and the large number of geographic units mapmakers could use to draw maps. State legislatures range in size from 40 (Alaska's lower chamber) to 203 (Pennsylvania's lower chamber). The number of census blocks, the smallest geographic unit upon which mapmakers can base districts, ranged from 24,114 in Delaware to 914,231 in Texas in the 2010 census. If an analyst were to use census blocks as the geographic unit from which he or she drew districts, then n=350,169 census blocks in New York in the 2010 census. Thus, the runtime for the present algorithm is expected to be between 10,000 and 15,000 orders of magnitude faster than the processing time of the Cirincione, Darling and O'Rourke (2000) algorithm, when using census block data to draw state assembly districts in New York. Perhaps more concretely, suppose the algorithm could draw a map of 150 districts from New York's 350,169 census blocks in 1.0 second. Asymptotic analysis indicates that Cirincione, Darling and O'Rourke's algorithm would take longer than 317×10⁹⁹⁹⁰ years to draw one map of New York's 150 districts from its 350,169 census blocks.

Demonstration

Texas, Virginia, and Mississippi provide an excellent context in which to apply the algorithm. All three states have significant minority populations, and all three states are located in the South. Prior to the Supreme Court ruling that invalidated Section 5 of the Voting Rights Act, all three states had to submit their redistricting plans to the Justice Department for pre-clearance. Shelby County v. Holder, 570 U.S. 2 (2013). Following the Court's decision in Thornburg v. Gingles, 478 U.S. 30 (1986), which encouraged the creation of districts in which minority population made up more than half the population, all three states took steps to create majority-minority districts. Several types of majority-minority districts are considered. For the purposes of analysis, majority-minority districts in Mississippi and Virginia are considered to be districts in which the US Census data categorizes 50% or more of the residents as “Black or African American alone.” In Texas, districts in which the census categorizes 50% or more of the residents as “Hispanic or Latino” are considered to be majority-minority districts. Alternatively, majority-minority districts may be districts in which more than 50% of the population of a district is non-Anglo, any resident not categorized as “Not Hispanic or Latino: White alone.” The analysis conducted here yields similar results regardless of how majority-minority districts are defined. Given the large minority populations in Texas (12.5% Black, 38.6% Hispanic), Virginia (19.7% Black, 8.9% Hispanic), and Mississippi (37.5% Black, 3% Hispanic) each state is a prime candidate for producing at least one majority-minority districts.

Summary Statistics

The goal of the analysis is to develop an approximate expectation of the distribution of minority residents between a state's districts if legislative map-makers only consider contiguity and population. In practice, the geographic distribution of minority voters and the political and legal contexts in which the congressional districts are devised inflate the number of majority-minority districts within a state. Since the algorithm only considers contiguity of geographical units and the total population of those units, it is neutral with regards to the politics or race of the individuals living in a given geographical unit. Consequently, the algorithm is neutral with regards to the output of the process. Since the algorithm generates each map by a different neutral and random process, the probability that any two maps are exactly alike is extremely small. The distribution of maps represents the counterfactual against which the actual map generated by the states analyzed can be compared. The distribution also allows characterization of the approximate probability by which the states' maps could have emerged from a neutral process. Of course, mapmakers in each state strove to comply with the Court's encouragement to generate majority-minority districts. Whether out of zeal to fulfill the courts instructions or out of some other motivation, each state in the analysis deviates in significant ways from neutral process of drawing districts.

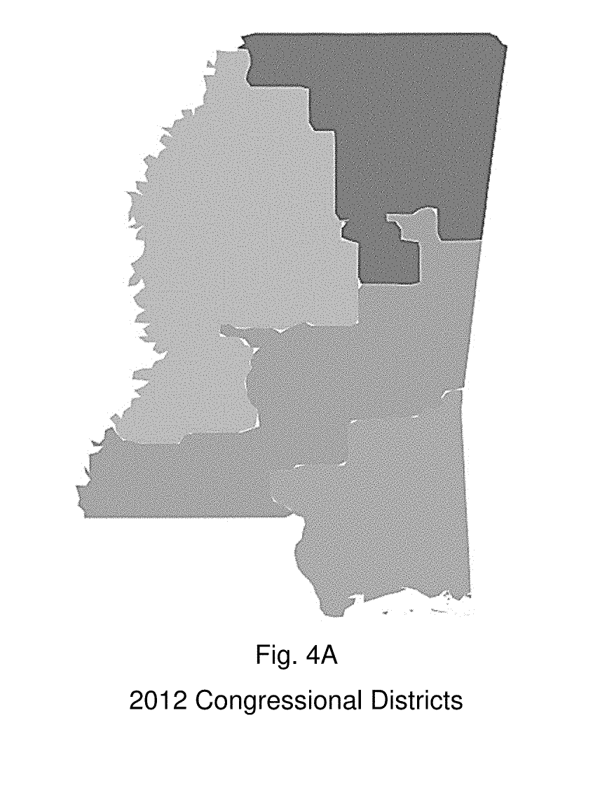

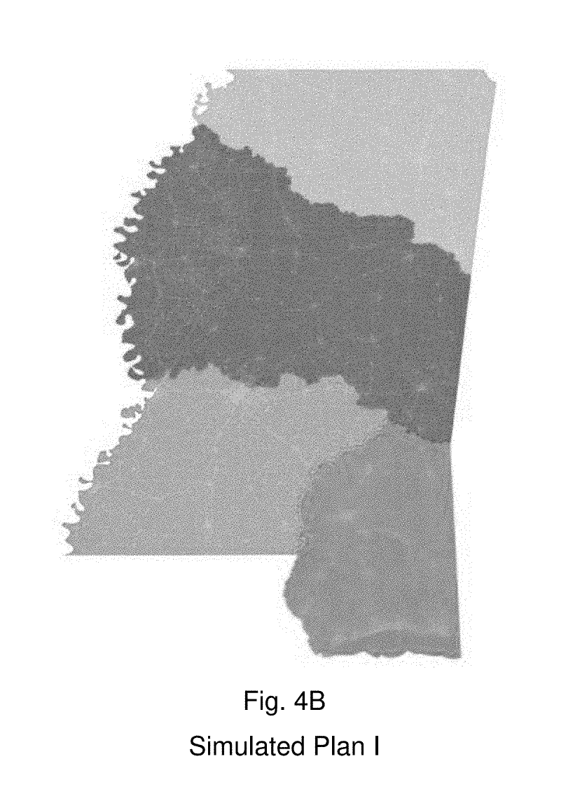

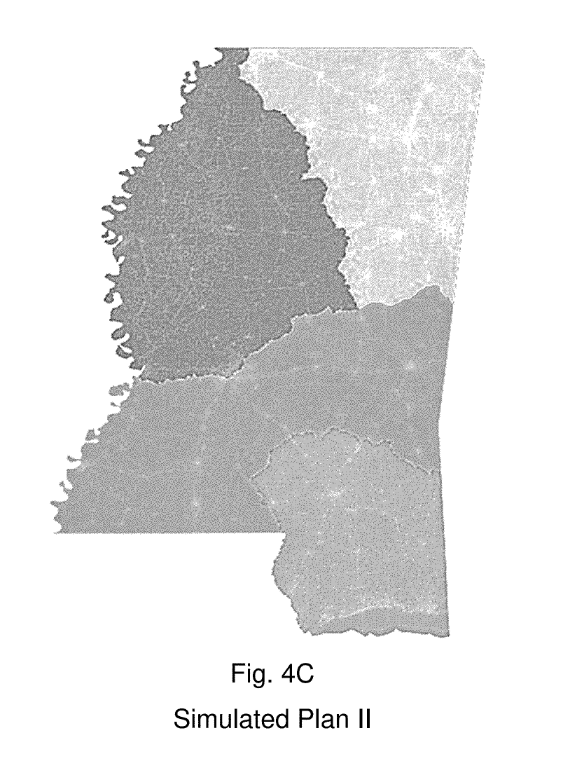

To draw neutral maps, data collected by the United States Census and made available by the Minnesota Population Center's National Historical Geographic Information System (NHGIS) project is employed. Census block-level geospatial and demographic data is employed. Census blocks are the smallest geographic unit for which information is available regarding population and includes reliable data regarding residents' demography. 10,000 maps of four, eleven, and thirty-six congressional districts for Mississippi, Virginia, and Texas respectively were generated (Magleby and Mosesson 2017). Representations of the kinds of districts the algorithm produces are visible in FIGS. 4A-D, 5A-D, and 6A-D. In FIGS. 4A, 5A, and 6A, the actual map of districts that each state used for the 2012 congressional elections is shown. As is clear from FIGS. 4A-D, 5A-D, and 6A-D, the algorithm generated relatively compact districts. Each was balanced to within 1.5% of the ideal for that state. The examples of neutral partitions of Mississippi included in FIGS. 4A-4D show how the maps generated by the algorithm diverge from the actual map used for the 2012 elections. Just as the actual plan does, the maps represented in FIG. 4B and 4C divide Jackson, one of the only urban areas in Mississippi, across two districts. By contrast the map in FIG. 4D keeps Jackson whole. Each example is a valid partition of Mississippi into four contiguous districts with roughly equal population.

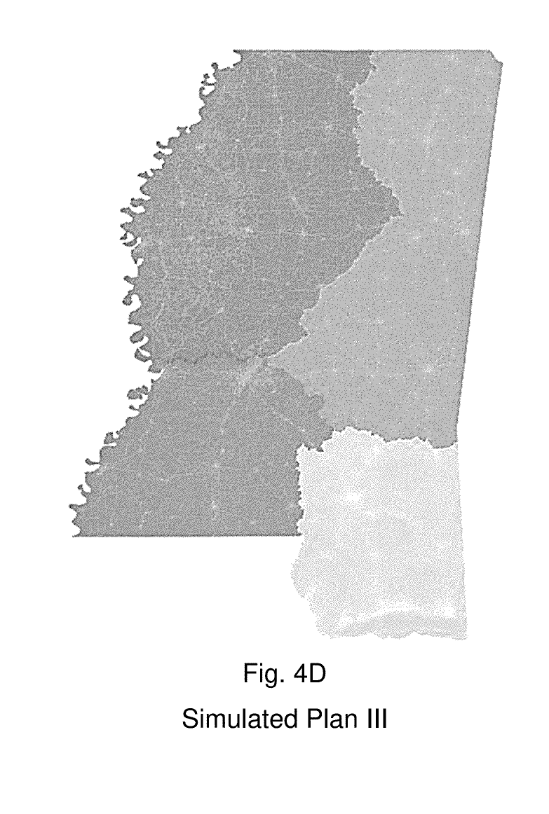

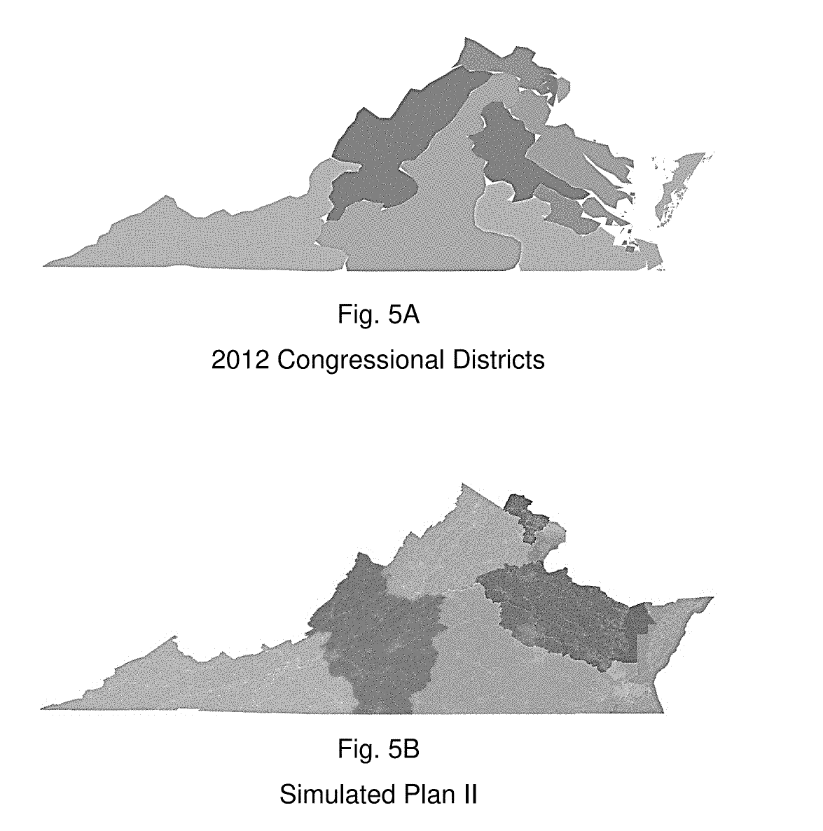

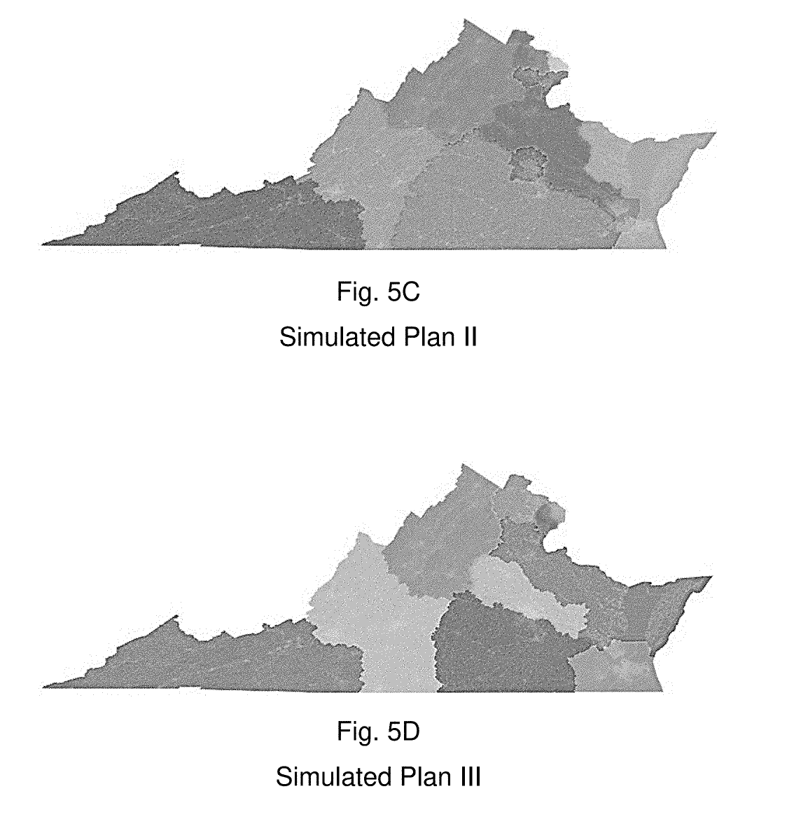

The algorithm also generated realistic districts in the larger state Virginia that show considerable variance in the composition of districts. Just like the actual map, the maps in FIGS. 5B, 5C, 5D show multiple districts in the densely populated areas around Washington, D.C. in Northern Virginia, but each of the example maps handled the other densely populated areas in and around Richmond and Hampton differently. Again, the algorithm only considers population and contiguity, so these example maps represent realistic, balanced, and neutral partitions of Virginia into eleven congressional districts.

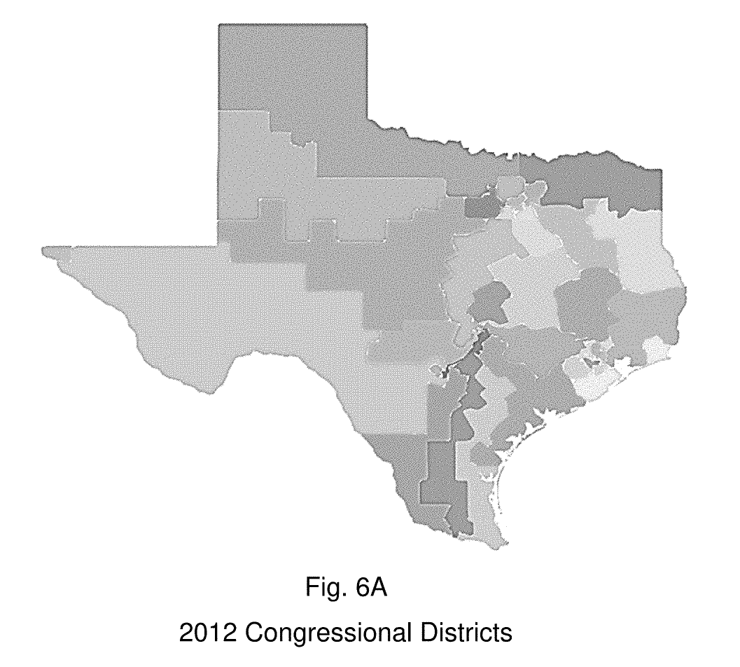

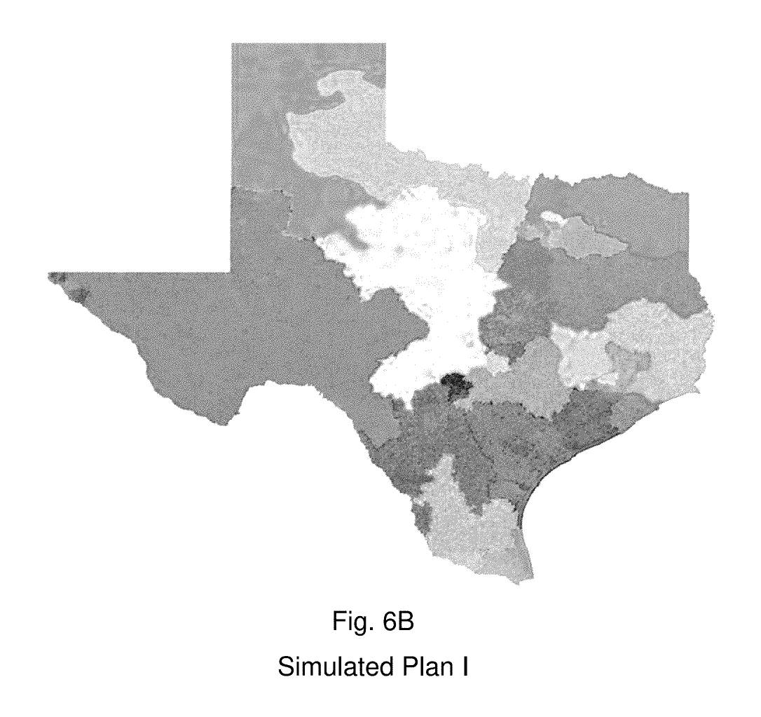

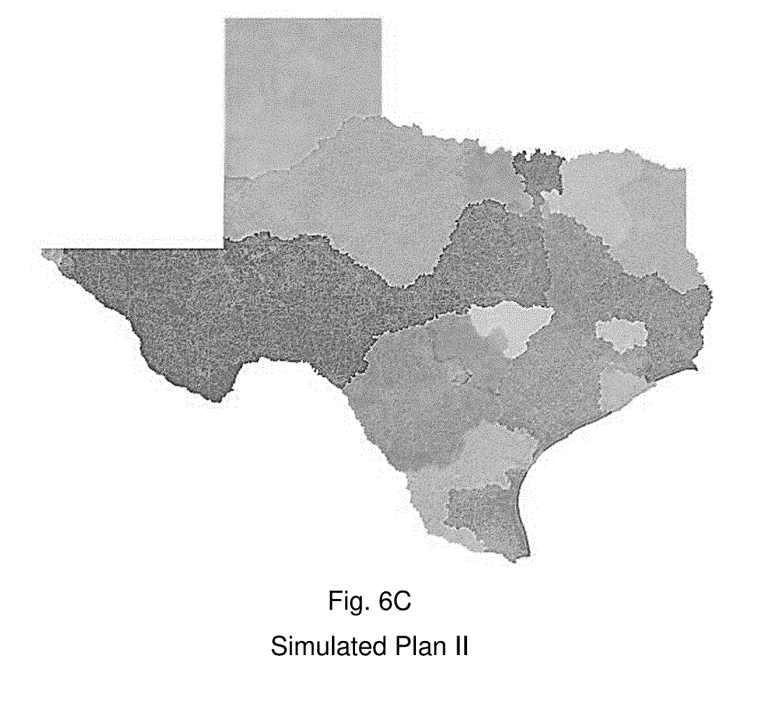

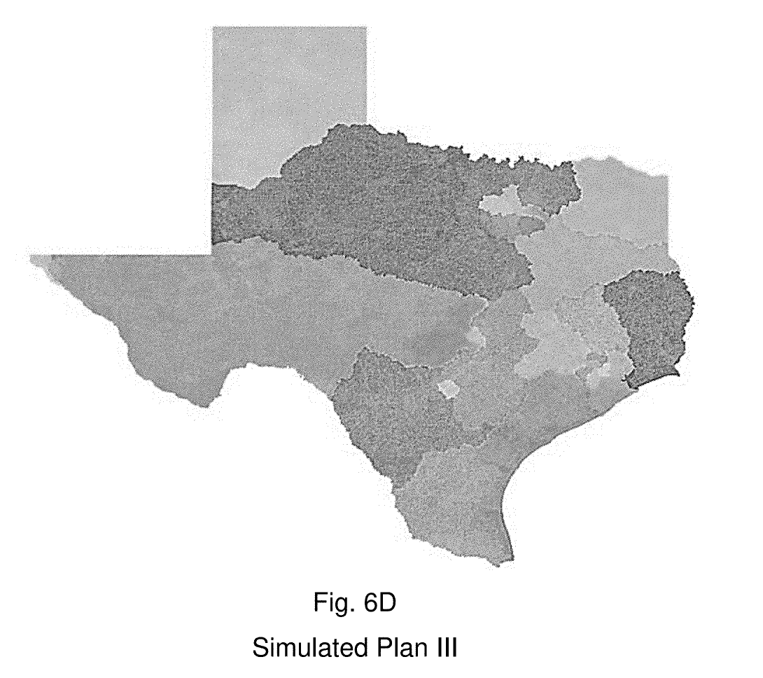

Finally, the algorithm generated a variety of realistic maps of Texas's congressional districts. The actual map, included here as FIG. 6A, has several districts in the densely populated Dallas, Houston, and Austin areas. FIGS. 6B, 6C, 6D, all have a geographically small districts in these more densely populated areas. Just like the actual map, each simulated map included here has a smaller district in the far west El Paso area, and geographically expansive districts covering sparsely populated West Texas and the Texas panhandle regions. One contrast between the simulated maps and the map in FIG. 6A is the way the maps deal with the highly Hispanic region of South Texas. Texas's 2012 map divides this heavily Latino area into three districts that run from the border with Mexico to Austin. The actual districts in this region are heavily Hispanic leaving neighboring districts with fewer Latino voters. The algorithm drew the examples in FIG. 6B, 6C, 6D without reference to race and divide up the heavily Hispanic population of South Texas neutrally. For some of these neutral maps, the result may be a more even distribution of Hispanic residents across more than three districts in South Texas.

State Performance

The algorithm retrieves an approximate null distribution of the number of majority-minority districts in each of the states examined. That is, it allows creation of an expectation of the number of majority-minority districts in each state, had mapmakers only considered population and the contiguity of geographic units that make up the district. Using census data on the racial composition of each state's actual congressional districts, the degree to which the racial composition of each state's actual districts diff from the neutral counterfactual retrieved by the algorithm is characterized. In the most recent round of redistricting following the 2010 census, blacks constituted a majority of the residents in one out of four congressional districts in Mississippi, two out of eleven congressional districts in Virginia. Hispanic residents were a majority in nine out of thirty-six districts in Texas.

TABLE 3

| | | No. of Majority- | Estimated |
|---|---|---|---|
| | | Minority Dists. in | Likelihood of 2012 |
| | Total Districts | 2012 Map | Maj-Min Dists. |
| Mississippi^{a} | 4 | 1 | p < 0.3073 |
| Virginia^{a} | 11 | 2 | p < 0.0001 |
| Texas^{b} | 36 | 9 | p < 0.1589 |

a Proportion of residents categorized as “Black or African American alone” greater than 0.5.
b Proportion of residents categorized as “Hispanic or Latino” greater than 0.5.

Table 3 shows a comparison of the actual number of majority-minority districts in Mississippi, Virginia, and Texas and estimates of the number of majority-minority districts in 10,000 simulated maps of congressional districts. Data on district and block-level demographics taken from the US Census data provided by NHGIS.

The data summarized in Table 3 provide an expectation of the number of majority-minority seats each state should produce. Those data indicate the probability that the actual number of majority-minority districts in Mississippi, Virginia, and Texas arose from a neutral process. In Mississippi, fewer than ⅓ of the simulated maps produced one majority black seat. The frequency of majority-minority seats in the simulated maps of Mississippi, 3,073/10,000 produced one majority black seat, may be interpreted to mean that there is less than an approximately 30.73% chance that the number of majority-minority districts actually observed in Mississippi arose from a neutral process. In Virginia, none of the 10,000 neutrally drawn maps produced a majority black district. Thus there is less than an approximately 0.001% chance that the actual map of Virginia's congressional district arose from a neutral process. Finally, 1,589/10,000 of neutrally drawn maps of Texas produced nine or more majority Hispanic districts. Thus, there is less than an approximately 16% chance that the actual map of Texas's congressional districts arose from a neutral process. In short, the notion that Mississippi (p<0.3073) and Texas (p<0.1589) produced the number of majority minority districts using a neutral process cannot confidently be rejected. On the other hand, it is extremely unlikely that Virginia (p<0.0001) arrived at two majority-minority districts by way of a neutral process. Cirincione, Darling and O'Rourke (2000) report a similar finding regarding South Carolina's 1990 congressional map. They use their algorithm to retrieve a null distribution; however, their algorithm partitioned relatively coarse block-groups into six districts making the redistricting problem relatively simpler than any of the redistricting problems presented above.

Possible Extensions

The algorithm neutrally generates a set of districts without indication of bias that are contiguous, balanced, and relatively compact; however, analysts may wish to apply additional constraints to the process of drawing legislative districts. For example, some jurisdictions seek to keep whole existing political units like municipalities or counties. In addition, map-makers may seek to generate a particular number of majority-minority districts. While imposition of additional constraints are not discussed above, these constraints may be applied as primary rules, limiting the valid maps, or as secondary criteria, which are used to select between valid maps. The criteria may be consolidated as an economic (dimensionless) distance function, or according to other known methods.

Applying additional constraints to the sample drawn by the algorithm requires; first that heterogeneity in the relationship between geographic units be permitted. Recall, geographic units (vertices) are weighted according to the number of people that reside in the unit. In the analysis presented above, all the relationships between units (edges) are weighted equally, but that need not be so. The approach could be altered to weight the relationship between units, and those weights could vary according to any number of factors of interest. For instance, higher weights might be applied to edges between vertices that should fall in the same district (e.g. units in the same municipality). Likewise, a lower weight could be applied to edges between units that need not fall in the same district (units not in the same municipality).

Second, the algorithm could be altered to minimize the weight of edges it cuts to create districts. Fortunately, there already exist a host of graph partitioning algorithms developed by computer scientists that minimize the edge cut while maintaining the balance in the weight applied to vertices across partitions (for example, see Karypis and Kumar 1995, 1998). These algorithms could be modified to address the problem of dividing geographic units into legislative districts. Using this approach, additional constraints are incorporated to study the impact of maintaining communities of interest (the practice of keeping cities and counties whole in legislative maps) and majority-minority districts on legislative districts and policy outcomes.

Conclusion

A computationally efficient algorithm is provided that generates a set of districts that are contiguous, balanced, relatively compact, and which do not show the kinds of biases found in previous algorithms. The algorithm has some correspondence to a load balancing algorithm which divides tasks weighted by computational complexity evenly between processors. Geographic units are analogous to tasks, and the population of the geographic units are the weights. The algorithm gains efficiency by first simplifying a map into a much simpler graph, partitioning the simpler version of the graph, and then projecting that partition back into the complex version of the map. In the last step of the process, the Kernigan-Lin algorithm may be applied, used by computer scientists to refine assignments of computational tasks to a computer's processor, to attain districts that are more balanced in terms of population.

Formal Presentation of Algorithm

Step 1 (“Coarsening”)

G₀ is transformed into a series of smaller graphs

G₁, G₂, G₃, . . . , Gₘ where |A₀|>|A₁|>|A₂|>|A₃|> . . . >|Aₘ|.

The algorithm selects a vertex uϵAᵢ with probability 1/n₁ where n₁=|Aᵢ|. If u has not been selected previously, then the algorithm matches u with vϵVᵢ^{u} with probability 1/|Vᵢ^{u}| where Vᵢ^{u} is the set of unmatched vertices adjacent to u. If ∃vϵVᵢ^{u}, then the algorithm collapses u and v into a multinode aⱼϵAᵢ₊₁. In Gᵢ₊₁, the weight of the multinode,

w(aⱼ)=w(u)+w(v), and

Ea=Eu∪Ev. If Vu=Ø,

then u remains unmatched. Unmatched vertices are copied over to Gᵢ₊₁.

Step 2 (“Partitioning”)

A k-way partition Pₘ of graph Gₘ is computed that divides Vₘ into k parts each containing |Aₘ|/k vertices. The algorithm chooses a multinode Aᵢ ϵAₘ with probability 1/|Aₘ|. It then chooses another block uϵVᵢ^{Ai} with probability 1/|Vᵢ^{Ai}| and combines the multimode into a district Pₘ[v].

If w(u)+w(Aᵢ)≥1/kW(Aₘ) or w(u)+w(Pₘ[v])≥1/kW(Aₘ),

the algorithm stops adding the multinode to the district.

If w(u)+w(Aᵢ)<½W(Aₘ) or w(u)+w(Pₘ[v])<½W(Aₘ),

then the algorithm repeats step 2; however, it chooses uϵV Pm[v] in every iteration after the first.

Step 3 (“Uncoarsening”)

By going through a the set of intermediate partitions Pₘ₋₁, Pₘ₋₂, . . . , P₁, P₀, the algorithm projects Pₘ of Gₘ back onto G₀. At every step of the uncoarsening process, the algorithm assigns Pᵢ[u]=Pᵢ₊₁[v], ∀v ϵVᵢ^{u}.

Step 4 (“Refinement”)

Consider a partition that has two parts v and u. For each Pₘ₋₁, Pₘ₋₁, . . . , P₀ in the uncoarsening step, let v and u be two parts of Pᵢ. The algorithm selects

v′ᵢ₊₁⊂vᵢ₊₁ and u′ᵢ₊₁⊂uᵢ₊₁,

where v′ᵢ₊₁ is contiguous with uᵢ₊₁ and u′ᵢ₊₁ is contiguous with vᵢ₊₁.

If |w(vᵢ₊₁)−w(uᵢ₊₁)|>|w(vᵢ₊₁\v′ᵢ₊₁∪u′ᵢ₊₁)−w(uᵢ₊₁\u′ᵢ₊₁∪v′ᵢ₊₁)|

then it sets vᵢ=vᵢ₊₁\vᵢ∪u′ᵢ₊₁ and uᵢ=uᵢ₊₁\uᵢ∪v′ᵢ₊₁

otherwise vᵢ=vᵢ₊₁ and uᵢ=uᵢ₊₁.

Step 5 (“Repeat”)

If the resulting partition is a set of contiguous and balanced districts, the partition is recorded for later analysis. If not, the flawed partition is discarded and the algorithm restarts.

The algorithm may be implemented on a general purpose computer, cloud computing system, mobile device, or the like. The computations may be performed in parallel, for example using GPU technology, both within a single graph partitioning run, and for generating the plurality of maps, though in the case of parallel production of maps, a second level process may be performed to ensure lack of duplication.

Algorithmic Complexity

TABLE 4
Asymptotic Cost Present Algorithm

| | Asymptotic Cost | |
|---|---|---|
| Step | (inclusive to current) | Assumptions |
| 1. Coarsening | Constant | None |
| 2. Partitioning | n² log n | The process of assigning a node to a partition |
| | | (multinode), is equivalent to sorting a list. Computer |
| | | scientists have shown that sorting a list requires n log n |
| | | operations. Since all nodes must be assigned to a |
| | | partition, this process must occur n times. Thus, |
| | | partitioning the graph requires n² log n operations. |
| 3. Uncoarsening | Constant | None |
| 4. Refinement | n² log nD log D | In order to achieve a balanced set of districts, the |
| | | algorithm trades nodes between districts. For every node |
| | | in either district a or district b, the best node is found |
| | | with which it may switch with a neighboring district. |
| | | This is equivalent to searching a sorted list, a log n |
| | | operation. The algorithm then finds the set of switches |
| | | that makes the partition more balanced, an O(n) |
| | | operation. The process of actually switching nodes is an |
| | | O(n) operation. This process is an inner operation that |
| | | has a complexity of O(n log n + n + n) which reduces to |
| | | O(n log n). The whole process repeats as long as the |
| | | previous iteration achieves a more balanced set of |
| | | partitions, this can happen up to n times. Thus, the |
| | | complexity of refining two districts is O(n2 log n). The |
| | | algorithm repeats this process for every pair of adjacent |
| | | districts in list of pairs ordered by imbalance, which has |
| | | complexity O(D log D). Thus, the whole process has a |
| | | complexity of O(D log Dn² log n) in the worst case. |

TABLE 5
Asymptotic Cost of Cirincione, Darling, and O'Rourke (2000)

| | Asymptotic | |
|---|---|---|
| | Cost (inclusive | |
| Step | to current) | Assumptions |
| 1. From the set of | Constant | |
| unassigned geographic | | |
| units, randomly select | | |
| one unit. | | |
| 2. Identify all units that | Constant | Maximum degree of a planar |
| are unassigned and | | graph is bounded above |
| adjacent to the selected | | by six, which is constant. |
| unit. | | |
| 3. Randomly select one | Constant | |
| of the adjacent | | |
| unassigned units and | | |
| add it to the district. | | |
| 4. Repeat Steps 2 and 3 | n/D | n/D units must be added to a |
| until the district reaches | | district |
| the predetermined | | |
| population threshold. | | |
| 5. Repeat Steps 1-4 | n | This must be done D times |
| until all units are as- | | |
| signed. | | |
| 6. Continue until algorithm draws D districts or restart if process cannot draw a | $\frac{n}{{\prod }_{1}^{D - 1} p ( n , 1 )}$ | Every time Steps 1-5 are run, there is chance that some partitions will not be contiguous. If the algorithm |
| contiguous district with | | is just taking a greedy walk |
| the required population. | | through the graph, there is |
| | | some probability function |
| | | p(n,i) that describes the |
| | | probability that the i^{th} district |
| | | will not be contiguous. This |
| | | leads the cost of the |
| | | algorithm to be a power |
| | | function of D. |

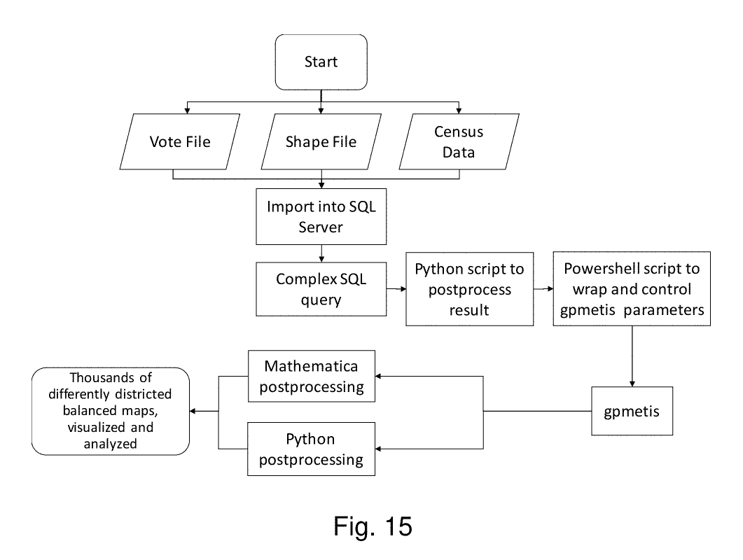

FIG. 15 shows a high level flow diagram for software for implementing the algorithm.

Application of Algorithm

As a demonstration of the algorithm's capabilities, an approximate distribution of neutral districts is compared to the actual congressional districts in Mississippi, Virginia, and Texas produced in the round of redistricting following the 2010 census. The algorithm generated 10,000 valid and distinct maps consisting of balanced and contiguous districts, from computationally intensive block-level data for each state. The patterns of minority concentration observed in each of these states are inconsistent with patterns that might have arisen through a neutral process. In other words, there appears to be a deliberate attempt by mapmakers in Mississippi, Virginia, and Texas to generate majority-minority seats. Absent such an effort, a set of districts are expected in each state that would make it challenging for minority voters to select a candidate of their choosing.

The concentration of minority voters almost certainly reverberates through the politics of each of these states. In particular, by concentrating minority voters, who tend to support Democratic candidates, into a few districts, mapmakers also concentrate Democratic voters into a few districts. The consequence is that the remaining districts are almost certainly more Republican than expected if the process of redistricting followed more neutral patterns. Therefore, the present technology may be usefully applied in the evaluation of potential racial or partisan gerrymanders.

A method is demonstrated for drawing neutral legislative districts that is an advance over prior published algorithms. The analysis allows formulation of substantive conclusions about legislative districts in Mississippi, Virginia, and Texas. The algorithm can be used to characterize the distribution of partisan voters in a null distribution. The null distribution retrieved by the algorithm also serves as a counterfactual against which patterns of partisanship in enacted maps can be compared.

Wisconsin

The technology was also used to analyze Wisconsin electoral districts, which were challenged in Federal District Court after the 2010 census. In the Wisconsin trial, the plaintiffs claim that the state's assembly map discriminates against Democratic voters by diluting the value of their votes—or to be simpler, that it's partisan gerrymandering.

There are lots of different ways that gerrymandered districts can be drawn to bias elections in one direction or another, but the most basic violation involves undermining majority rule. If the districts are drawn so that one party regularly wins a majority of seats with a minority of votes, that's biased in a way that most people would find undemocratic.

To determine whether Wisconsin's assembly map is undemocratic, the median and mean two-party vote in the 99 assembly districts in statewide elections are compared.

The “mean” vote across assembly districts is obtained by adding each party's percentage of the vote in each district, and dividing by the number of districts, or 99. The “median” district vote, by contrast, is what is obtained by listing the districts from most Democratic to most Republican (by percentage of the vote) and choosing the one exactly in the middle. The mean and median should be nearly the same in a fair system. If the median district is only 45 percent Democratic, then the chances of a Democrat winning it is slim—and therefore the Democrats are very unlikely to win a majority of the legislature. In this case, if the mean district was also 45 percent Democratic, there'd be no bias in the system and the Democrats would be getting what they deserve when they fail to take control of the assembly.

But, if the mean district was 51 or 52 percent Democratic, the mapmakers could have adjusted the map to make the median district far more Republican than it “should” be. Based on this analysis, Wisconsin's districts distinctly favor Republicans.

In Wisconsin, the difference between median and mean Republican/Democratic district-level vote favors Republican voters by between 3.8 to 6.3 percentage points in every statewide election from 2008 to 2014. While Wisconsin voters were actually voting in slightly different districts in 2008 and 2010—before the map was redrawn—the state of Wisconsin estimates what the 2008 and 2010 votes would be in current assembly districts. (The Wisconsin Legislative Technology Services Bureau is required by law to produce block-level estimates of voting for past elections on current census blocks.)

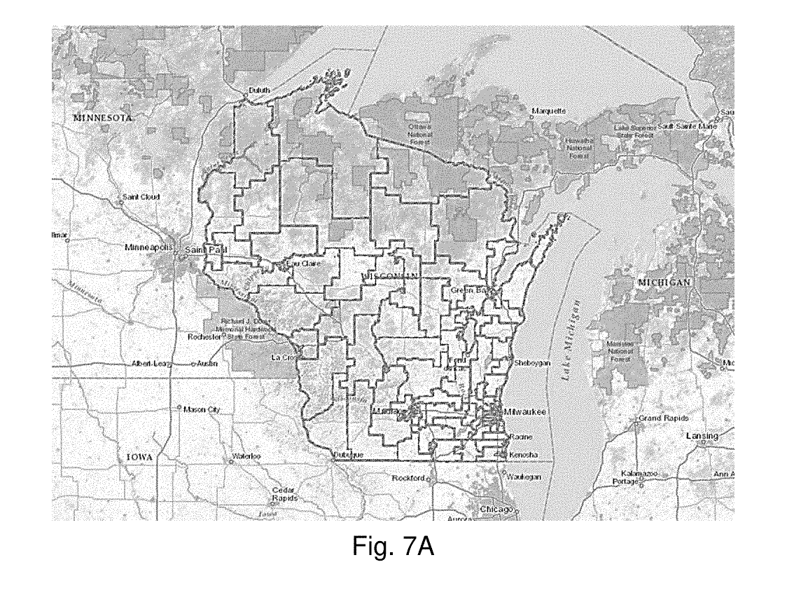

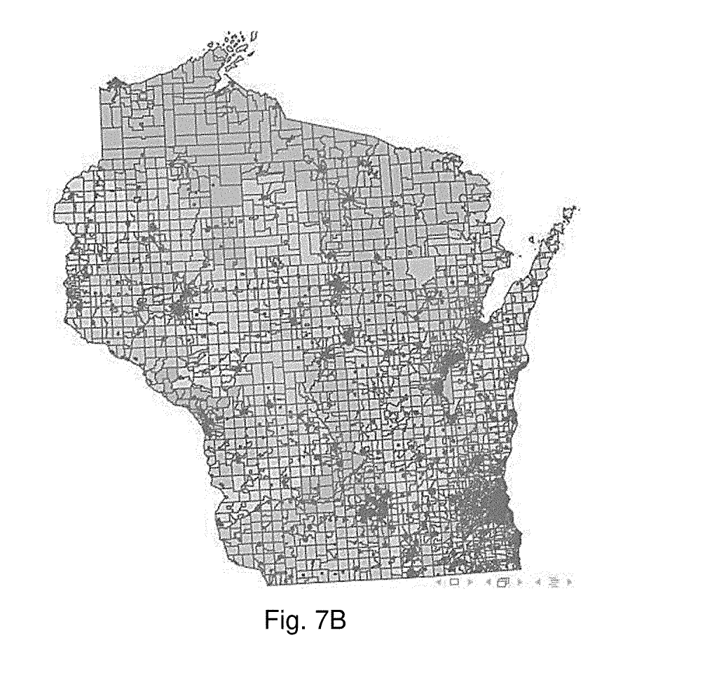

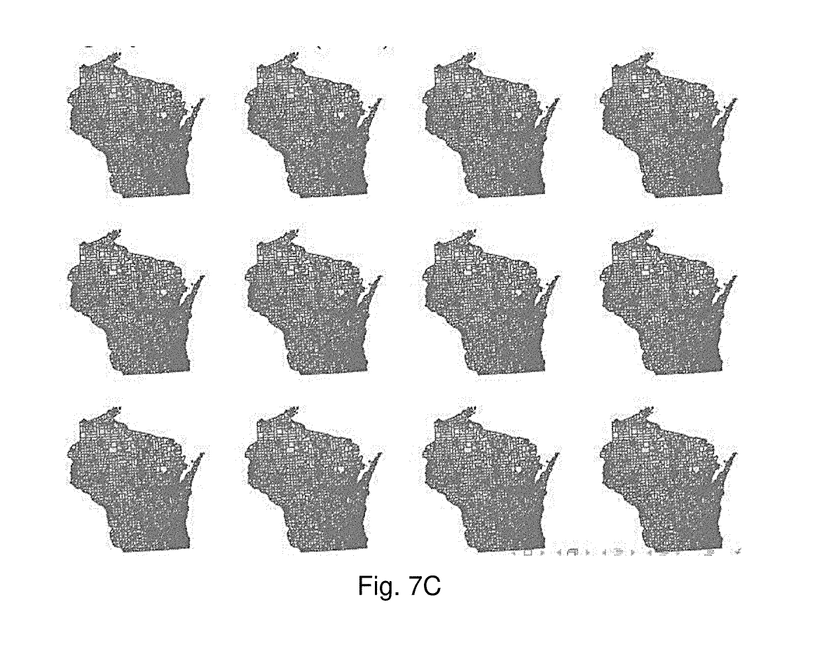

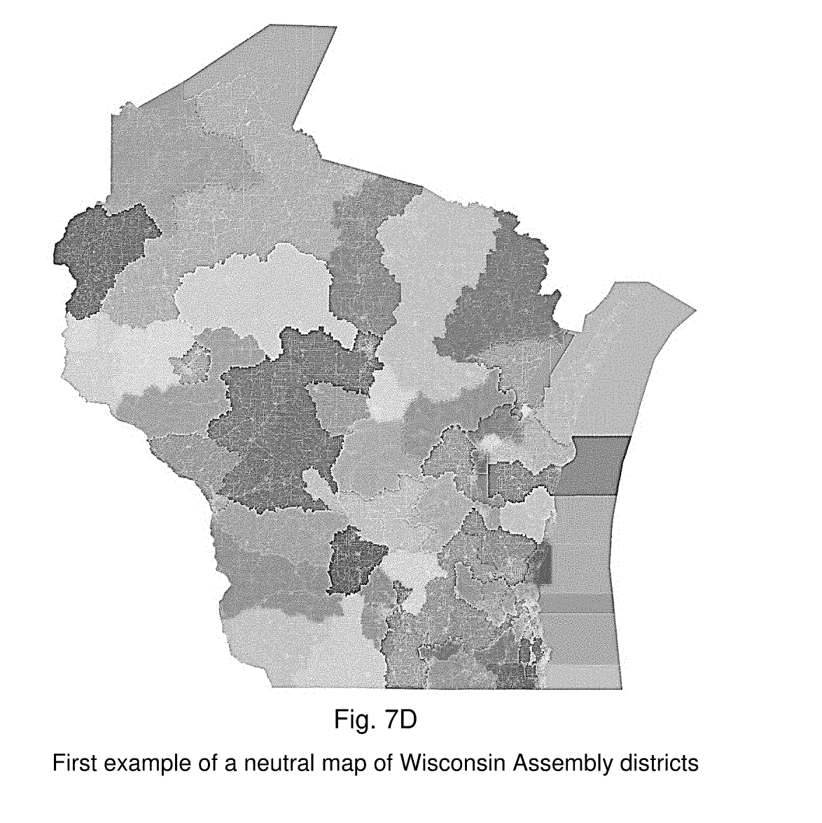

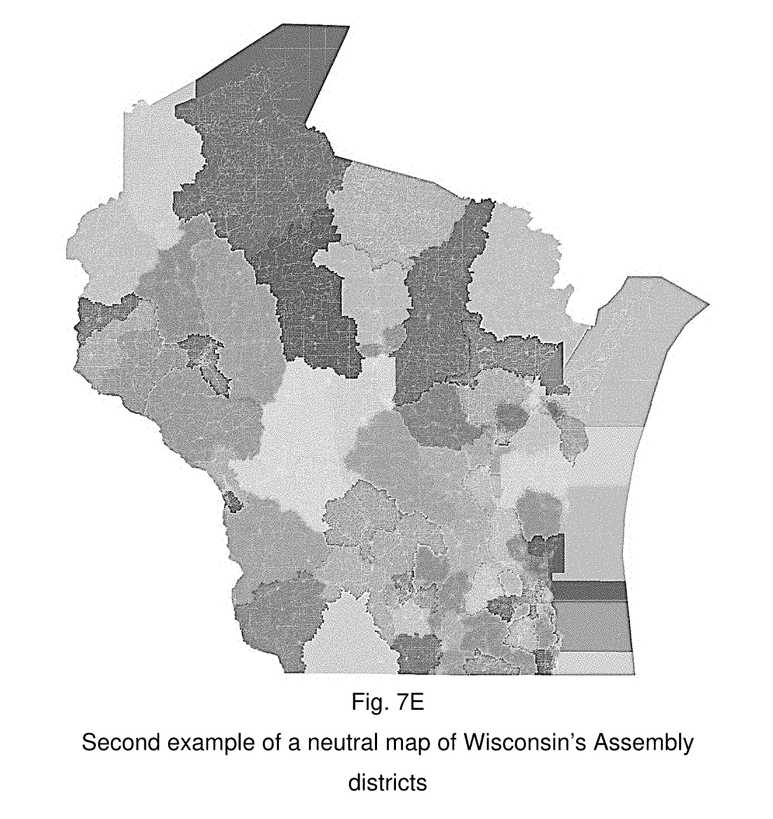

One objection to this analysis is that it doesn't take into account the “natural gerrymander” (just in Wisconsin, but around the country) in which each party's voters tend to cluster in different districts. In Wisconsin that means lots of Democratic voters live in cities like Madison and Milwaukee. To test that hypothesis, a computer-mapping technique as described herein, was used to draw 10,000 alternative, neutral assembly maps using census blocks. Wisconsin law requires that districts be contiguous and equally populated. The 10,000 maps do that and are drawn without information about voting. See, FIGS. 7A-7E.

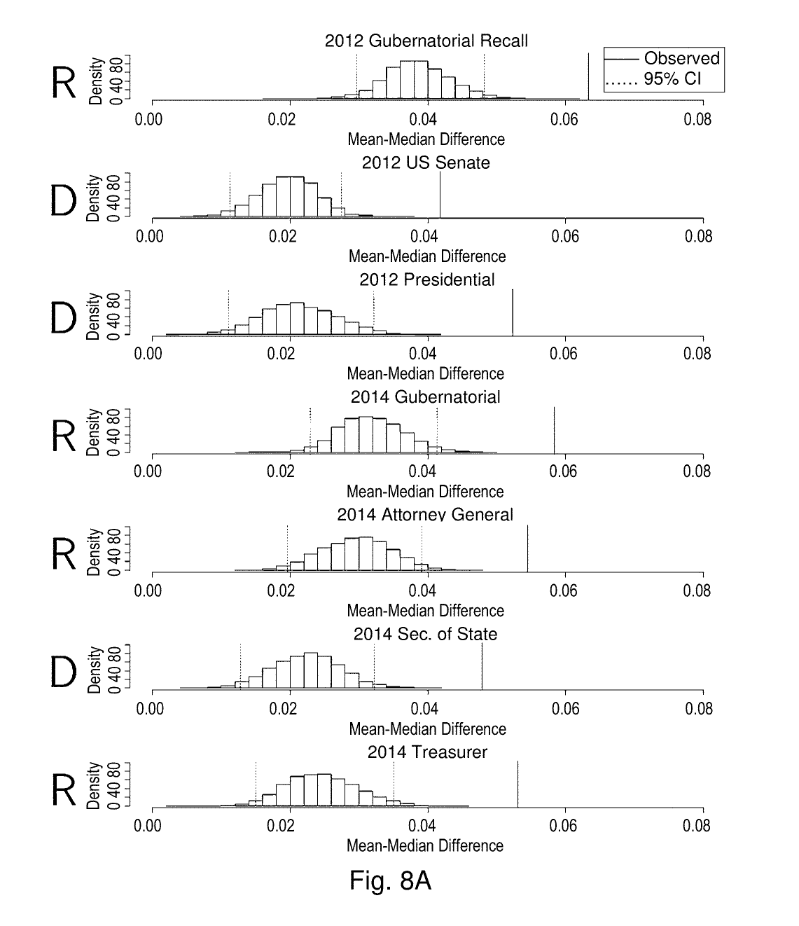

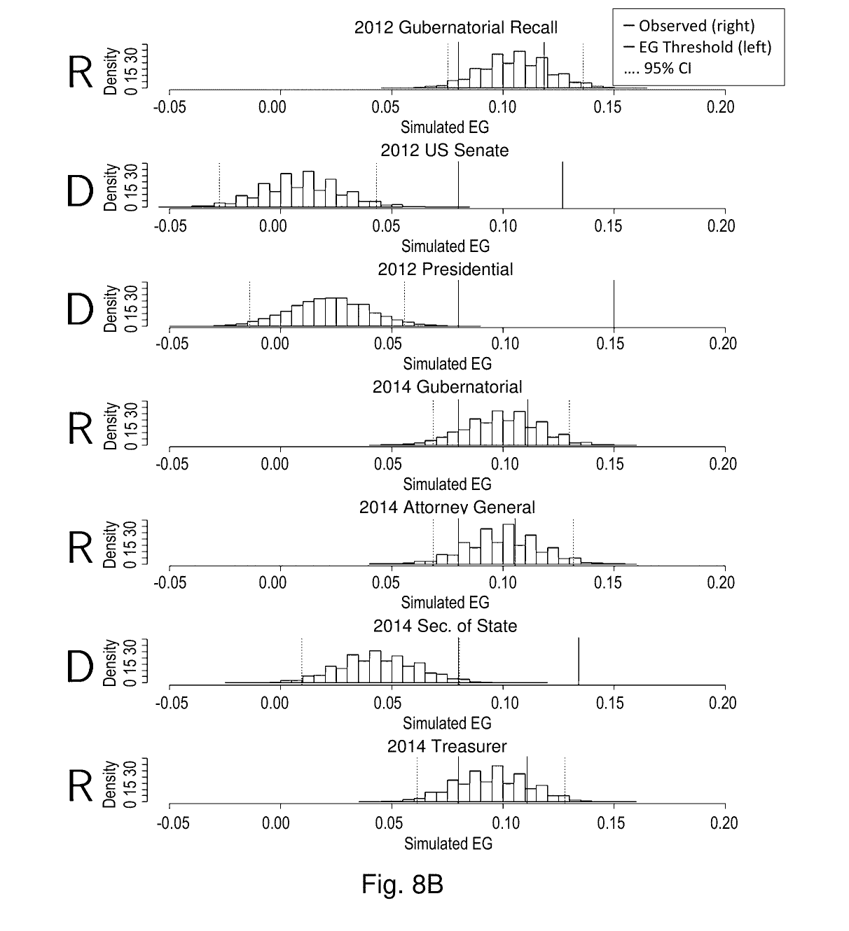

These neutral maps show a natural gerrymander of 1.1 to 3.9 percentage points (using the same median-mean comparison) favoring the Republicans. See, FIGS. 8A and 8B. This is smaller than the total bias of 3.8 to 6.3 percentage points in the current map. However, what is extraordinary is that none of the 10,000 neutral maps produced a plan as skewed toward the Republicans, in any of the 13 statewide elections from 2008 to 2014 that examined, as the actual map drawn by the state assembly. Therefore, one may conclude that Wisconsin's state legislative districts were drawn to add an additional, thick layer of bias atop the “natural” gerrymander of where Republicans and Democrats live in the state.

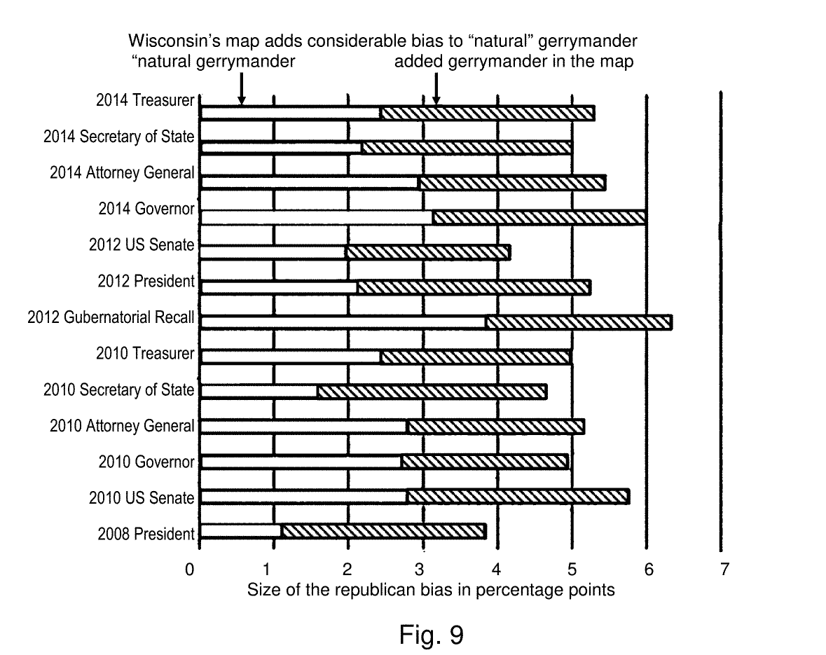

This can be seen in FIG. 9, which shows the average difference between the median and the mean Republican/Democratic votes in the neutral maps, on the one hand, and in the actual districts, on the other. The shaded gray area under the line of the neutral maps represents the “natural” gerrymander. The shaded area above it is the “unnatural gerrymander” added by the state's map. That added 2 to 3 points of bias in every election from 2008 to 2014.

What this means is that Democrats probably have to win about 55 to 56 percent of the statewide vote to win control of the state assembly. Or to put it differently, Republicans need only win 44 to 45 percent.

Data for 252,596 census blocks were acquired from the state covering elections from 2002 to 2014. The reliability of these data were tested by deriving our estimates of block-level voting in 2012 and 2014 following a similar procedure as the described by Wisconsin's analysts. The comparisons showed minute differences between these estimates and the state's. The state's numbers have the advantages of being official in the sense that they are created by public law and being the data undoubtedly relied upon by mapmakers in the most recent redistricting cycle. They also bridge redistricting cycles.

These data were augmented with an expansive array of 10,000 neutral maps drawn by computer. The possibility of using computer-generated maps to evaluate districts was first suggested by Nobel Laureate economist William Vickrey in a 1961 article. A number of scholars have attempted to follow up on his call, including Cirincione, Darling, and O'Rouke (2000), Altman and McDonald (2011), Chen and Cottrell (2014), and Chen and Rodden (2013; 2015), all of whom share the same analytical approach to solving this problem. McDonald and Altman even produced open-source statistical package, “BARD,” to allow others, including Chen and Rodden, to follow in their path. The enormous complexity of the problem of dividing thousands of geographic units into a smaller number of equally populated and contiguous districts limits the applications of these processes, always to VTDs as opposed to blocks and often to smaller states or smaller number of legislative seats. The Magleby and Mosesson approach (2016), by contrast, is enormously more efficient and thus allows huge numbers of maps to be produced using block-level data. While observing all possible maps that might be drawn of state legislative districts in a jurisdiction like Wisconsin is infeasible, Magleby and Mosesson have shown that their process has no discernable biases under existing tests. Following their lead, these maps are referred to as neutral, in that they are generated with no conditions other than contiguity and (relatively) equal population. For the purposes of the present analysis, the Magleby and Mosesson has another advantage: no other automated redistricting process is efficient enough to produce a reasonable number of maps containing ninety-nine districts based on census-block level data in a jurisdiction the size of Wisconsin.

To give a sense of how these maps look, two examples randomly drawn from the sample of 10,000—map #6 and map #20, in FIGS. 7D and 7E. Both feature 99 contiguous districts via the principle of “point contiguity” whereby two areas may be connected to each other only at a single point, the same standard used by the courts. The largest population deviation in any of the 10,000 maps is 1.5%, well within the limit of 10% for state legislative seats, and all districts were confirmed as being contiguous and each map is unique.

The maps produce a neutral baseline against which to compare Wisconsin's existing districts. Absent some sort of basis of comparison, it is difficult to tell whether some observed efficiency gap or median-mean comparison is large or small, or how likely it is to occur essentially by neutral mapmaking processes. This is particularly important in light of often remarked upon tendency for Democrats to be slightly disadvantaged by so-called ‘accidental’ or ‘natural’ gerrymanders as a result of concentrations of large numbers of Democrats in urban areas (Erikson 1972, 1237; Veith v. Jubelirer 2004, 289-90; Chen and Rodden 2013). Such conditions are known to exist in Wisconsin with its high concentrations of Democrats in Milwaukee and Madison. The plaintiffs in Whitford produce a comparison set to make their case that Wisconsin's current Assembly map is a fairly substantial Republican gerrymander via Jackman's estimates of the efficiency gap in Wisconsin and in other states going back several decades. No good way exists to test for contiguity post hoc, but the way the maps are generated from an adjacency matrix insures that non-contiguous districts should not be possible (Magleby and Mosesson 2016). The adjacency matrix is regenerated to look for variations and rendered a random sample of maps to submit to the “eyeball test.”

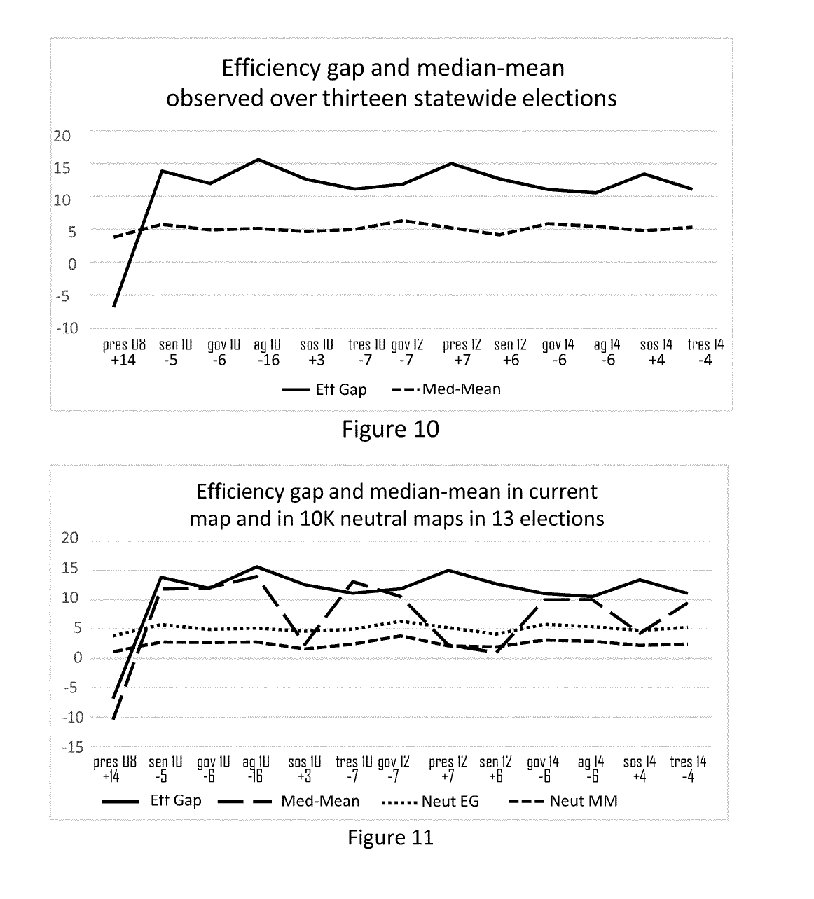

The efficiency gap and median-mean comparison are calculated using ward returns for each of the thirteen statewide elections conducted between 2008 and 2012. It is important to reiterate that the actual votes for Democratic and Republican statewide candidates are used, and not those running for the Assembly, both in the current district lines (which the state reports) and the rearranged blocks of the neutral maps. These results are displayed in FIG. 10. The elections are arrayed on the X-axis (in the order they occurred and their position on the ballot) and the magnitude of the efficiency gap and median-mean comparison are the Y-axis. As expected, the median-mean test shows a clear Republican bias in Wisconsin's Assembly map in all of these elections, with an observed pro-Republican bias ranging from 3.84 points (in the 2008 presidential race) to 6.33 points (in the 2012 gubernatorial recall). The results of the efficiency gap calculation are somewhat less clear cut. The sign of the gap in the 2008 presidential election (−6.83) suggests that the current Assembly map favored the Democrats in that year, albeit not by a sufficient magnitude to register as a gerrymander. In all of the other elections, however, the efficiency gap is strongly positive and indicates that the Assembly map is a fairly substantial Republican gerrymander. Note that the numbers below the election on the x-axis refer to the result of the election for the Democrats (e.g. pres 08+14 indicates a 14-point Democratic victory in that election).

Both tests suggest that Wisconsin's current Assembly map is a pro-Republican gerrymander at least in the most recent elections. These results by themselves, however, do not provide any context as to how extreme this gerrymander may be or whether it is the byproduct of a natural gerrymander caused by residential patterns. Both issues can be addressed by comparing the measures of observed bias in Wisconsin's current map with the same measures derived from the 10,000 computer-generated maps. FIG. 11 repeats the same setup as FIG. 10, with dashed lines added for the mean efficiency gap and the median-mean comparison across the 10,000 neutral districts. The relationship between the median-mean in the actual map and the neutral maps is, again, straightforward. In each contest the bias favors the Republicans and is appreciably larger (by about 2 to 3 points) in the actual map than in the neutral maps. Indeed, the median-mean in the neutral maps shows a natural gerrymander of between 1 and 4 points evident in every race, with an additional level of bias—an “unnatural gerrymander”—added on top by the Assembly map.

The story told by the efficiency gap is less clear. The dashed line showing the mean efficiency gap in the neutral maps moves wildly, and in several races exceeds the efficiency gap registered by the adopted map. In other cases, the efficiency gap in the neutral maps declines below the threshold of a gerrymander. In theory the neutral maps would be expected to produce relatively steady results that fall short of being gerrymanders because there is no a priori reason to suspect that very many of them could be gerrymanders given they are generated purely by continuity and population. Data on voting are only merged with the block assignments afterward in order to calculate the median-mean and efficiency gap. Still it is telling that the distance between the efficiency gap in the current Assembly boundaries and the average across the neutral maps is greatest in races that Democrats won, with the exception of the 2008 presidential. This is likely a sign of Republican gerrymandering in the current Assembly map which protects Republican candidates even in the face of the mild headwind of moderately-sized Democratic victory statewide, and so the difference between the efficiency gaps in the current map and the neutral maps grows in these contests.

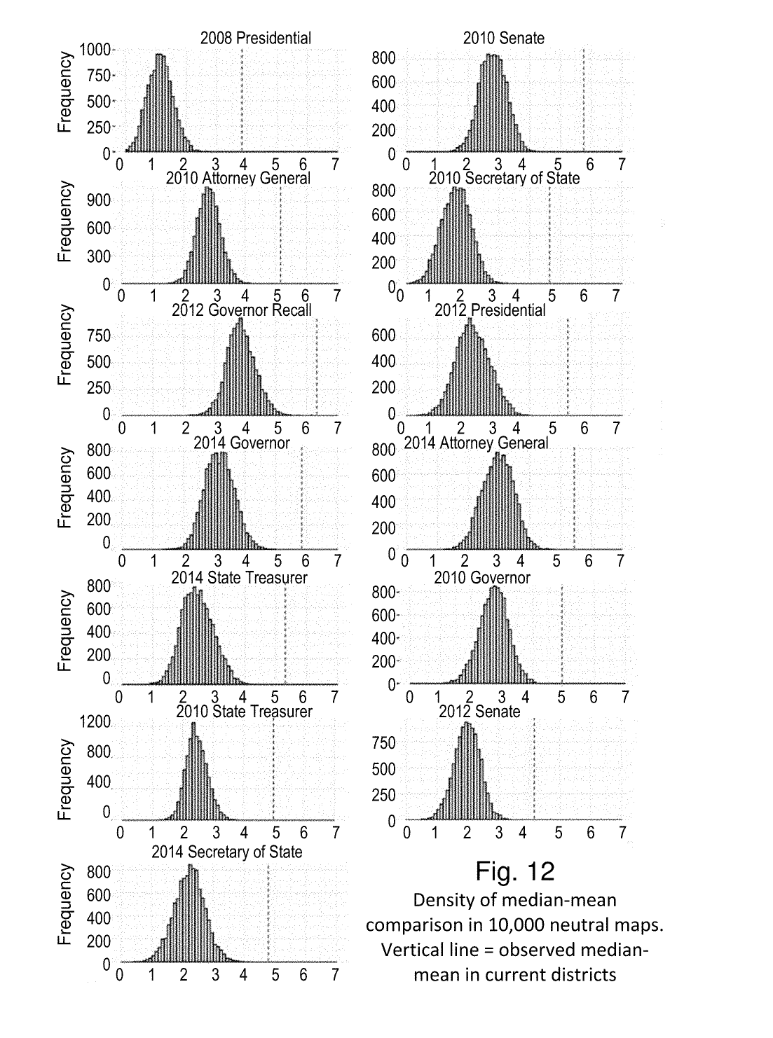

Summarizing the results of 10,000 maps by reporting the mean efficiency gap and median-mean comparison misses other key information about this large array of alternative maps. Accordingly, density graphs were produced for each measure across all elections. The thirteen panels in FIG. 12 show histograms of frequency of median-mean comparisons in the neutral maps, with the size of the bias on the X-axis and the number of observations on the Y-axis. The observed median-mean in the existing map is drawn in as a dashed line. As expected, the pictures show a fairly steep and normal distribution of values around the mode. Most important, they show no overlap between the median-mean comparison in any of the neutral maps and in any of the elections. That is, none of the maps, a set of 130,000 comparisons of the status quo to 10,000 maps in thirteen different elections, have a pro-Republican bias as large as the map adopted by Wisconsin's legislature. Given the unknown distribution of possible maps, hesitancy is exercised to place a probability on the likelihood of drawing boundaries with the partisan bias of Wisconsin's Assembly. However, the neutral maps show that the state's Assembly boundaries are clearly a gerrymander that substantially dilutes the weight of the state's Democratic votes vis-à-vis the goal of winning a majority of Assembly seats.

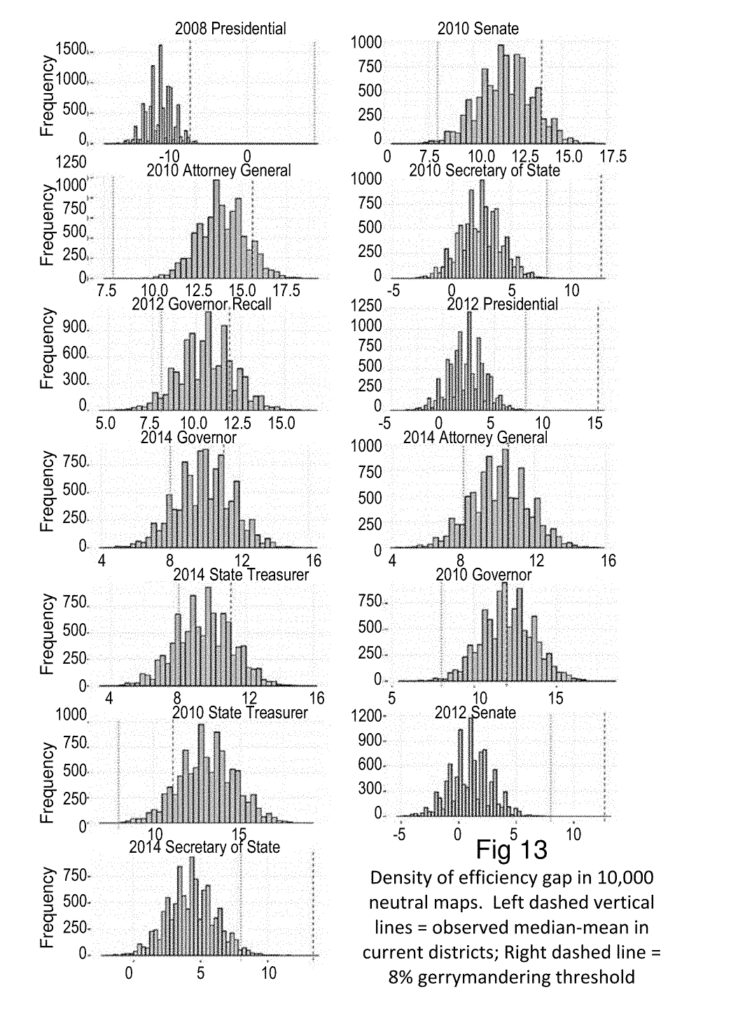

The array of neutral maps, however, tells a different story about the efficiency gap. FIG. 13 repeats the setup of FIG. 12, with an added vertical line at the 8% threshold where Stephanopoulos and McGhee say that gerrymanders may be detected. First, it is plain that that the distribution of efficiency gaps observed is much broader than is the relatively compact range of median-mean scores. More ominously, though, a substantial degree of overlap is observed between the efficiency gaps of the maps generated by the neutral process and the existing Assembly map in eight races won by Republicans. In fact, using returns from those elections reveals that large majorities of the neutral maps yield efficiency gap scores above 8% and thus would register as gerrymanders. Several points stand out here. First, as in FIG. 12, there is an enormous amount of variation in the efficiency gap observed in different elections, though this variation is somewhat muted in the actual map in use in Wisconsin because of the way it protects Republican majorities. In the neutral maps that do not protect those majorities, the efficiency gap is liable to swing dramatically with changes in the parties' political fortunes. As speculated below, the story of the 2008 presidential result may be a large enough Democratic victory to make the current map seem like a Democratic gerrymander.

Second, and more important, the neutral maps suggest that the efficiency gap is highly susceptible to producing what appear to be false positives, findings that indicate a gerrymander is present when there no reason to expect there to be one. Of course, by the standards of the efficiency gap itself, these are not false positives; they are gerrymanders. This is a non-falsifiable proposition, yet it seems highly implausible. In each of the eight races won by Republicans, at least 77.9% of the neutral maps register as gerrymanders according to the efficiency gap in that they score above the 8% threshold. In four of the five races won by Democrats, setting aside the 2008 presidential election, virtually none of the same maps register as gerrymanders.

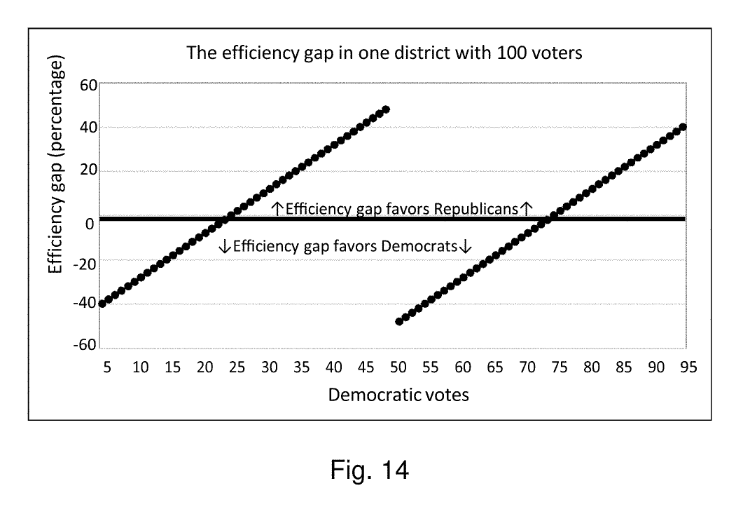

As noted, the key aspect of the efficiency gap is the insight that both winning and losing parties waste votes in an election. To get a better sense about how that works out across a jurisdiction with multiple districts, consider how efficiency gap moves as election results may vary in a single district. FIG. 14 shows the efficiency gap in a district with 100 voters where the results range from 5 to 95 votes for the Democrat shown on the X-axis, with the Republican receiving all remaining votes. At the Democrat's low point, the efficiency gap favors her or him because the party wastes the 5 votes it receives compared to 45 for the Republican, for a gap of −40%. (Since 100 voters are assumed, there is no need to divide by the number of voters; the difference in votes wasted equals the efficiency gap.) From that point the line proceeds monotonically upward with the efficiency gap increasing (in the positive direction toward 0) until just before 50% where the sign flips, and the pattern is repeated until at 95 the efficiency gap is 40 and favors the Republican.

Several things stand out here. There are no less than three points in FIG. 14 where the sign flips and a small movement in the vote switches net efficiency from favoring one party to favoring another, at 25, 50, and 75 votes. The most apparent and important flip is near 50 where there is a discontinuity so that at 49 there is a sizable efficiency gap favoring Republicans (all 49 Democratic votes are wasted versus just 1 Republican vote), but at 51 an equally-sized efficiency gap now favors Democrats. This raises the stakes of any map with a relatively large number of competitive districts, because small changes in votes could produce dramatic swings in the efficiency gap. Tellingly, there are just two points in FIG. 14 where the efficiency gap equals zero, at precisely 25 and 75, for it is only at these points where the winning and losing parties both waste the same number of votes. The winner's margin of 75% functions as a pivot point: percentages above it are biased in favor of the loser and percentages below it are biased in favor of the winner. In fact, any result outside the winner winning with between 71% and 79% of the vote generates an efficiency gap greater than 8% —despite the fact that that there can be no gerrymander in a single district. Here the term “false positive” is applicable to describe these results. This is a classic failure of criterion validity and it suggests that votes may be wasted for reasons beyond bias in a map.

In theory, these extreme variations in net waste cancel each out across multiple districts and convey a reliable and sensible measure of electoral bias. Indeed, the large efficiency gaps in most cases considered in FIG. 14 aggregated across 99 Assembly districts in Wisconsin, are unusual. But for the efficiency gap to be a reliable measure of bias across a number of districts factors beyond gerrymandering cannot influence how wasted votes are distributed. This brief foray into the measurement qualities of wasted votes provides reasons for doubting this is so, or that wasted votes reliably balance out so neatly and accurately. To start, a well-designed gerrymander will create a number of districts that narrowly, but not too narrowly, favor the mapmakers' party in an effort to maximize the value of their voters' ballots. That situation, correctly, produces a sizable efficiency gap favoring that party. But a partisan tide strong enough to pull many of the close seats to the other party's column might yield an efficiency gap suggesting that the gerrymander favors the otherwise disadvantaged party, at least until the next election.

Implementation

Exemplary hardware for performing the technology includes at least one automated processor (or microprocessor) coupled to a memory. The memory may include random access memory (RAM) devices, cache memories, non-volatile or back-up memories such as programmable or flash memories, read-only memories (ROM), etc. In addition, the memory may be considered to include memory storage physically located elsewhere in the hardware, e.g. any cache memory in the processor as well as any storage capacity used as a virtual memory, e.g., as stored on a mass storage device.

The hardware may receive a number of inputs and outputs for communicating information externally. For interface with a user or operator, the hardware may include one or more user input devices (e.g., a keyboard, a mouse, imaging device, scanner, microphone) and a one or more output devices (e.g., a Liquid Crystal Display (LCD) panel, a sound playback device (speaker)). To embody the present invention, the hardware may include at least one screen device.

For additional storage, as well as data input and output, and user and machine interfaces, the hardware may also include one or more mass storage devices, e.g., a floppy or other removable disk drive, a hard disk drive, a Direct Access Storage Device (DASD), an optical drive (e.g. a Compact Disk (CD) drive, a Digital Versatile Disk (DVD) drive) and/or a tape drive, among others. Furthermore, the hardware may include an interface with one or more networks (e.g., a local area network (LAN), a wide area network (WAN), a wireless network, and/or the Internet among others) to permit the communication of information with other computers coupled to the networks. It should be appreciated that the hardware typically includes suitable analog and/or digital interfaces between the processor and each of the components is known in the art.

The hardware operates under the control of an operating system, and executes various computer software applications, components, programs, objects, modules, etc. to implement the techniques described above. Moreover, various applications, components, programs, objects, etc., collectively indicated by application software, may also execute on one or more processors in another computer coupled to the hardware via a network, e.g. in a distributed computing environment, whereby the processing required to implement the functions of a computer program may be allocated to multiple computers over a network.

In general, the routines executed to implement the embodiments of the present disclosure may be implemented as part of an operating system or a specific application, component, program, object, module or sequence of instructions referred to as a “computer program.” A computer program typically comprises one or more instruction sets at various times in various memory and storage devices in a computer, and that, when read and executed by one or more processors in a computer, cause the computer to perform operations necessary to execute elements involving the various aspects of the invention. Moreover, while the technology has been described in the context of fully functioning computers and computer systems, those skilled in the art will appreciate that the various embodiments of the invention are capable of being distributed as a program product in a variety of forms, and may be applied equally to actually effect the distribution regardless of the particular type of computer-readable media used. Examples of computer-readable media include but are not limited to recordable type media such as volatile and non-volatile memory devices, removable disks, hard disk drives, optical disks (e.g., Compact Disk Read-Only Memory (CD-ROMs), Digital Versatile Disks (DVDs)), flash memory, etc., among others. Another type of distribution may be implemented as Internet downloads. The technology may be provided as ROM, persistently stored firmware, or hard-coded instructions.

While certain exemplary embodiments have been described and shown in the accompanying drawings, it is understood that such embodiments are merely illustrative and not restrictive of the broad invention and that the present disclosure is not limited to the specific constructions and arrangements shown and described, since various other modifications may occur to those ordinarily skilled in the art upon studying this disclosure. The disclosed embodiments may be readily modified or re-arranged in one or more of its details without departing from the principals of the present disclosure.

Implementations of the subject matter and the operations described herein can be implemented in digital electronic circuitry, computer software, firmware or hardware, including the structures disclosed in this specification and their structural equivalents or in combinations of one or more of them. Implementations of the subject matter described in this specification can be implemented as one or more computer programs, i.e., one or more modules of computer program instructions, encoded on one or more computer storage medium for execution by, or to control the operation of data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a non-transitory computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices).

Accordingly, the computer storage medium may be tangible and non-transitory. All embodiments within the scope of the claims should be interpreted as being tangible and non-abstract in nature, and therefore this application expressly disclaims any interpretation that might encompass abstract subject matter.

The present technology provides analysis that improves the functioning of the machine in which it is installed, and provides distinct results from machines that employ different algorithms.

The operations described in this specification can be implemented as operations performed by a data processing apparatus on data stored on one or more computer-readable storage devices or received from other sources.

The term “client or “server” includes a variety of apparatuses, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, a code that creates an execution environment for the computer program in question, e.g., a code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The architecture may be CISC, RISC, SISD, SIMD, MIMD, loosely-coupled parallel processing, etc. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone (e.g., a smartphone), a personal digital assistant (PDA), a mobile audio or video player, a game console, or a portable storage device (e.g., a universal serial bus (USB) flash drive). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well. For example, feedback provided to the user can be any form of sensory feedback, e.g., visual feedback, auditory feedback, or tactile feedback and input from the user can be received in any form, including acoustic, speech, or tactile input. In addition, a computer can interact with a user by sending documents to and receiving documents from a device that is used by the user. For example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are considered in a particular order, this should not be understood as requiring that such operations be performed in the particular order shown, in sequential order or that all operations be performed to achieve desirable results. In certain circumstances, multitasking and parallel processing may be advantageous. Moreover, the separation of various system components in the implementations described above should not be understood as requiring such separation in all implementations and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

### REFERENCES

Each of which is expressly incorporated herein by reference in its entirety:
Altman, Micah and Michael P. McDonald. 2004. “A Computation-Intensive Method for Evaluating Intent in Redistricting”. Prepared for the 2004 Annual Meeting of the Midwest Political Science Association.
Altman, Micah and Michael P. McDonald. 2011. “BARD: Better automated redistricting.” Journal of Statistical Software 42(4):1-28.
Altman, Micah, Brian Amos, Michael P. McDonald and Daniel A. Smith. 2015. “Revealing Preferences: Why Gerrymanders are Hard to Prove, and What to Do about It.” Available at SSRN 2583528.
Altman, Micah, Jeff Gill and Michael P McDonald. 2004. “Numerical issues in statistical computing for the social scientist”. Vol. 508 John Wiley & Sons.
Andreev, Konstantin; Räcke, Harald, (2004). “Balanced Graph Partitioning”. Proceedings of the sixteenth annual ACM symposium on Parallelism in algorithms and architectures. Barcelona, Spain: 120-124. doi:10.1145/1007912.1007931. ISBN 1-58113-840-7.
Apollonio, N., R. I. Becker, I. Lari, F. Ricca, and B. Simeone. “Bicolored graph partitioning: or, how to win elections.”
Aykanat, Cevdet, B. Barla Cambazoglu, and Bora Uçar. “Multi-level direct k-way hypergraph partitioning with multiple constraints and fixed vertices.” Journal of Parallel and Distributed Computing 68.5 (2008): 609-625;
Berman, Mitchell N. “Managing Gerrymandering.” Tex L. Rev. 83 (2004): 781.
Best, Robin, Jonathan Krasno, Robin Best, Jonathan Krasno, Daniel Mogleby, Michael D. McDonald, “Detecting Florida's Gerrymander: A Lesson for Law and Social Science.” Forthcoming. Social Science Quarterly. with.
Best, Robin, Shawn J. Donahue, Jonathan Krasno, Daniel Mogleby, and Michael D. McDonald. in Challenges of U.S. Electoral Integrity eds. Pippa Norris, Sarah Cameron and Thomas Wynter “Analyzing Gerrymandering's Offense to Electoral Integrity.” New York: Oxford University Press. forthcoming.
Best, Robin, Shawn J. Donahue, Jonathan Krasno, Daniel Mogleby, and Michael D. McDonald. “Can Gerrymanders Be Measured? An Examination of Wisconsin's State Assembly.” Forthcoming. American Politics Research.
Best, Robin, Shawn J. Donahue, Jonathan Krasno, Daniel Mogleby, and Michael D. McDonald, “Values and Validations: Proper Criteria for Comparing Standards of Packing Gerrymandering.” 2017. Election Law Journal.
Best, Robin, Shawn J. Donahue, Jonathan Krasno, Daniel Mogleby, and Michael D. McDonald “Considering the Prospects for Identifying a Gerrymandering Standard.” 2017. Election Law Journal.
Bodin, Lawrence D. “A districting experiment with a clustering algorithm.” Annals of the New York Academy of Sciences 219, no. 1 (1973): 209-214.
Bozkaya, Burcin, Erhan Erkut and Gilbert Laporte. 2003. “A tabu search heuristic and adaptive memory procedure for political districting.” European Journal of Operational Research 144(1):12-26.
Browdy, Michelle H. 1990. “Simulated annealing: an improved computer model for political redistricting.” Yale Law & Policy Review pp. 163-179.
Browning, Robert X., and Gary King. “Seats, Votes, and Gerrymandering: Estimating Representation and Bias in State Legislative Redistricting.” Law & Policy 9.3 (1987): 305-322.
Bruce Hendrickson. “Chaco: Software for Partitioning Graphs”.
Buluc, Aydin; Meyerhenke, Henning; Safro, Ilya; Sanders, Peter; Schulz, Christian (2013). Recent Advances in Graph Partitioning. arXiv:1311.3144.
Butler, David E. 1952. “The British General Elections of 1951”. London: Oxford University Press.
Carlos Alzate; Johan A. K. Suykens (2010). “Multiway Spectral Clustering with Out-of-Sample Extensions through Weighted Kernel PCA”. IEEE Transactions on Pattern Analysis and Machine Intelligence. IEEE Computer Society. 32 (2): 335-347. doi:10.1109/TPAMI.2008.292. ISSN 0162-8828. PMID 20075462.
Catalyürek, Ü; C. Aykanat (2011). PaToH: Partitioning Tool for Hypergraphs.
Catalyurek, Umit V., et al. “A repartitioning hypergraph model for dynamic load balancing.” Journal of Parallel and Distributed Computing 69.8 (2009): 711-724;
Chamberlain, Bradford L. (1998). “Graph Partitioning Algorithms for Distributing Workloads of Parallel Computations”
Charles-Edmond Bichot; Patrick Siarry (2011). Graph Partitioning: Optimisation and Applications. ISTE—Wiley. p. 384. ISBN 978-1848212336.
Chen, Jowei and David Cottrell. 2014. “Evaluating Partisan Gains from Congressional Gerrymandering: Using Computer Simulations to Estimate the Effect of Gerrymandering in the US House.”
Chen, Jowei and Jonathan Rodden. 2013. “Unintentional gerrymandering: Political geography and electoral bias in legislatures.” Quarterly Journal of Political Science 8(3):239-269.
Chen, Jowei and Jonathan Roden. 2015. “Cutting Through the Thicket: Redistricting Simulations and the Detection of Partisan Gerrymanders”. Election Law Journal. 14(4): 331-345.
Chevalier, C.; F. Pellegrini (2008). “PT-Scotch: A Tool for Efficient Parallel Graph Ordering”. Parallel Computing. 34 (6): 318-331. doi:10.1016/j.parco.2007.12.001.
Cho, Wendy K Tam and Yan Y Liu. 2016. “Toward a Talismanic Redistricting Tool: A Computational Method for Identifying Extreme Redistricting Plans.” Election Law Journal 15(4):351-366.
Chou, Chung-I and Sai-Ping Li. 2006. “Taming the gerrymander—statistical physics approach to political districting problem.” Physica A: Statistical Mechanics and its Applications 369(2):799-808.
Cirincione, Carmen, Thomas A. Darling and Timothy G. O'Rourke. 2000. “Assessing South Carolina's 1990s congressional districting.” Political Geography 19(2):189-211.
Cox, Adam B., and Richard Holden. “Reconsidering Racial and Partisan Gerrymandering.” (2011).
De Assis, Laura Silva, Paulo Morelato Franca, and Fábio Luiz Usberti. “A redistricting problem applied to meter reading in power distribution networks.” Computers & Operations Research 41 (2014): 65-75.
Devine, K.; E. Boman; R. Heaphy; R. Bisseling; Ü. Catalyurek (2006). Parallel Hypergraph Partitioning for Scientific Computing. Proceedings of the 20th International Conference on Parallel and Distributed Processing. pp. 124-124.
Diekmann, R.; R. Preis; F. Schlimbach; C. Walshaw (2000). “Shape-optimized Mesh Partitioning and Load Balancing for Parallel Adaptive FEM”. Parallel Computing. 26 (12): 1555-1581. doi:10.1016/s0167-8191(00)00043-0.
Doyle, Shawn. “A Graph Partitioning Model of Congressional Redistricting.” Rose-Hulman Undergraduate Mathematics Journal 16, no. 2 (2015): 3.
Dube, Matthew P., and Jesse T. Clark. “Beyond the Circle: Measuring District Compactness Using Graph Theory.” In Annual Meeting of the Northeastern Political Science Association. 2016.
Edgeworth, Francis Ysidro. 1898. “Miscellaneous applications of the calculus of probabilities, contd”. Journal of the Royal Statistical Society 51: 534-544.
Engstrom, Richard L. and John K. Wildgen. 1977. “Pruning Thorns from the Thicket: An Empirical Test of the Existence of Racial Gerrymandering.” Legislative Studies Quarterly 2(4):465-479.
Erikson, Robert S. 1972. “Malapportionment, Gerrymandering, and Party Fortunes in Congressional Elections”. American Political Science Review 66: 1234-45.
Feldmann, Andreas Emil (2012). “Fast Balanced Partitioning is Hard, Even on Grids and Trees”. Proceedings of the 37th International Symposium on Mathematical Foundations of Computer Science. Bratislava, Slovakia.
Feldmann, Andreas Emil (2012). Balanced Partitioning of Grids and Related Graphs: A Theoretical Study of Data Distribution in Parallel Finite Element Model Simulations. Goettingen, Germany: Cuvillier Verlag. p. 218. ISBN 978-3954041251. An exhaustive analysis of the problem from a theoretical point of view.
Feldmann, Andreas Emil; Foschini, Luca (2012). “Balanced Partitions of Trees and Applications”. Proceedings of the 29th International Symposium on Theoretical Aspects of Computer Science. Paris, France: 100-111.
Fiduccia, C M; R M Mattheyses (1982). A Linear-Time Heuristic for Improving Network Partitions. Design Automation Conference. A later variant that is linear time, very commonly used, both by itself and as part of multilevel partitioning, see below.
Fifield, Benjamin, Michael Higgins, Kosuke Imai and Alexander Tan. 2015. “redist: Markov Chain Monte Carlo Methods for Redistricting Simulation.” available at the Comprehensive R Archive Network (CRAN). URL: cran.r-project.org/package=redist
Fifield, Benjamin, Michael Higgins, Kosuke Imai and Alexander Tan. 2016. “A New Automated Redistricting Simulator Using Markov Chain Monte Carlo.”.
Friedman, John N., and Richard T. Holden. “Optimal gerrymandering: sometimes pack, but never crack.” The American Economic Review 98.1 (2008): 113-144.
Friedman, John N., and Richard T. Holden. “The rising incumbent reelection rate: What's gerrymandering got to do with it?.” The Journal of Politics 71.2 (2009): 593-611.
Fryer Jr, Roland G. and Richard Holden. 2011. “Measuring the Compactness of Political Districting Plans.” Journal of Law and Economics 54(3):493-535.
Fuentes-Rohwer, Luis. “Doing Our Politics in Court: Gerrymandering, Fair Representation and an Exegesis into the Judicial Role.” Notre Dame L. Rev. 78 (2002): 527.
Garey, Michael R.; Johnson, David S. (1979). Computers and intractability: A guide to the theory of NP-completeness. W. H. Freeman & Co. ISBN 0-7167-1044-7.
Garfinkel, Robert S. and George L Nemhauser. 1970. “Optimal political districting by implicit enumeration techniques.” Management Science 16(8):B-495.
Gilligan, Thomas W., and John G. Matsusaka. “Structural constraints on partisan bias under the efficient gerrymander.” Public Choice 100.1 (1999): 65-84.
Gottfredson, Linda S. “Racially gerrymandering the content of police tests to satisfy the US Justice Department: A case study.” Psychology, Public Policy, and Law 2.3-4 (1996): 418.
Grofman, Bernard, and Gary King. “The future of partisan symmetry as a judicial test for partisan gerrymandering after LULAC v. Perry.” Election Law Journal 6.1 (2007): 2-35.
Grofman, Bernard. “Political gerrymandering and the courts”. Vol. 3. Algora Publishing, 2003.
Gupta, Anshul. “Fast and effective algorithms for graph partitioning and sparse-matrix ordering.” IBM Journal of Research and Development 41.1.2 (1997): 171-183;
Guo, Diansheng, Shufan Liu, and Hai Jin. “A graph-based approach to vehicle trajectory analysis.” Journal of Location Based Services 4.3-4 (2010): 183-199.
Guo, Jessica, Gerardo Trinidad, and Nariida Smith. “MOZART: A multi-objective zoning and aggregation tool.” In Proceedings of the Philippine Computing Science Congress (PCSC), pp. 197-201. 2000.
Hagen, L.; Kahng, A. B. (September 1992). “New spectral methods for ratio cut partitioning and clustering”. IEEE Transactions on Computer-Aided Design of Integrated Circuits and Systems. 11, (9): 1074-1085. doi:10.1109/43.159993.
Hendrickson, Bruce and Robert Leland. 1995. “A Multi-Level Algorithm For Partitioning Graphs”. In Supercomputing, 1995. Proceedings of the IEEE/ACM SC95 Conference. IEEE pp. 28-28.
Hendrickson, Bruce, and Robert Leland. The Chaco user's guide: Version 2.0. Vol. 4. Technical Report SAND95-2344, Sandia National Laboratories, 1995;
Issacharoff, Samuel. “Gerrymandering and political cartels.” Harvard Law Review (2002): 593-648.
Jackman, Simon. “Assessing the Current Wisconsin State Legislative Districting Plan”. Jul. 7, 2015. Submitted by Plaintiff's in Whitford v. Nichol, Case 3:15-cv-00421 (Wisc. E.D. 2015-pending).
Jacobellis v. Ohio, 378 U.S. 184 (1964).
Johnson, Shawn. 2016a. “Expert: Republicans ‘Virtually 100 Percent’ Certain To Retain Majorities Under GOP Map.” Wisconsin Public Radio. URL: www.wpr.org/expert-republicans-virtually-100-percent-certain-retain-majorities-under-gop-map
Johnson, Shawn. 2016b. “Wisconsin Gerrymandering Trial Wraps Up.” Wisconsin Public Radio. URL: www.wpr.org/wisconsin-gerrymandering-trial-wraps
Johnston, Ron. “Manipulating maps and winning elections: measuring the impact of malapportionment and gerrymandering.” Political Geography 21.1 (2002): 1-31.
Joshi, Deepti, Leen-Kiat Soh, and Ashok Samal. “Redistricting using heuristic-based polygonal clustering.” In Data Mining, 2009. ICDM′09. Ninth IEEE International Conference on, pp. 830-835. IEEE, 2009.
Karypis, G. and Aggarwal, R. and Kumar, V. and Shekhar, S. (1997). Multilevel hypergraph partitioning: application in VLSI domain. Proceedings of the 34th annual Design Automation Conference. pp. 526-529.
Karypis, G., Aggarwal, R., Kumar, V., and Shekhar, S. (March 1999). “Multilevel hypergraph partitioning: applications in VLSI domain”. IEEE Transactions on Very Large Scale Integration (VLSI) Systems. 7 (1): 69-79. doi:10.1109/92.748202. Graph partitioning (and in particular, hypergraph partitioning) has many applications to IC design.
Karypis, G.; Kumar, V. (1999). “A fast and high quality multilevel scheme for partitioning irregular graphs”. SIAM Journal on Scientific Computing. 20 (1): 359-392. doi: 10.1137/S 1064827595287997.
Karypis, George, and Vipin Kumar. “Parallel multilevel series k-way partitioning scheme for irregular graphs.” Siam Review 41.2 (1999): 278-300;
Karypis, George and Vipin Kumar. 1995. Analysis of multilevel graph partitioning. In Proceedings of the 1995 ACM/IEEE conference on Supercomputing. ACM p. 29.
Kernighan, Brian W. and Shen Lin. 1970. “An efficient heuristic procedure for partitioning graphs.” Bell system technical journal 49(2):291-307.
Kirkpatrick, S.; C. D. Gelatt Jr.; M. P. Vecchi (13 May 1983). “Optimization by Simulated Annealing”. Science. 220 (4598): 671-680. doi:10.1126/science.220.4598.671. PMID 17813860. Simulated annealing can be used as well.
Koren, Yehuda, and David Harel. “A multi-scale algorithm for the linear arrangement problem.” Graph-theoretic concepts in computer science. Springer Berlin/Heidelberg, 2002;
Kurve, Griffin, Kesidis (2011) “A graph partitioning game for distributed simulation of networks” Proceedings of the 2011 International Workshop on Modeling, Analysis, and Control of Complex Networks: 9-16
League of United Latin American Citizens v. Perry, 548 U.S. 399 (2006).
Legislative Technology Services Bureau. Wisconsin State Legislature. legis.wisconsin.gov/ltsb/gis/data/
Lowenstein, Daniel H. “Vieth's Gap: Has the Supreme Court Gone from Bad to Worse on Partisan Gerrymandering.” Cornell JL & Pub. Pol'y 14 (2004): 367.
Magelby, Daniel B. and Daniel Mosseson. 2016. “Neutral Redistricting Using a Multi-Level Weighted Graph Partitioning Algorithm”. Unpublished manuscript.
Magleby, Daniel and Daniel Mosesson. 2017. “Replication Data for: A New Approach for Developing Neutral Redistricting Plans.” URL: dx.doi.org/10.7910/DVN/R9GKJA
Malesky, Edmund. “Gerrymandering—Vietnamese style: escaping the partial reform equilibrium in a nondemocratic regime.” The Journal of Politics 71.1 (2009): 132-159.
Mayer, Kenneth. R. “Analysis of the Efficiency Gaps of Wisconsin's Current Legislative District Plan and Plaintiffs' Demonstration Plan”. Jul. 3, 2015. Submitted by Plaintiff's in Whitford v. Nichol, Case 3:15-cv-00421 (Wisc. E.D. 2015-pending)
McCarty, Nolan, Keith T. Poole and Howard Rosenthal. 2009. “Does gerrymandering cause polarization?” American Journal of Political Science 53(3):666-680.
McDonald, Michael D and Robin E Best. 2015. “Unfair Partisan Gerrymanders in Politics and Law: A Diagnostic Applied to Six Cases.” Election Law Journal 14(4):312-330.
McDonald, Michael D., Jonathan Krasno, and Robin E. Best. 2011. “An Objective and Simple Measure of Gerrymandering: A Demonstration from New York State”. Presented at the 2011 Annual Meeting of the Midwest Political Science Association.
McGann, Anthony J., Charles Anthony Smith, Michael Latner, and Alex J. Keena. 2015. “A Discernable and Manageable Standard for Partisan Gerrymandering”. Election Law Journal: Rules, Politics, and Policy. 14: 295-311.
McGhee, Eric. 2014. “Measuring Partisan Bias in Single-Member District Electoral Systems”. 39 Legislative Studies Quarterly 55: 68-69.
Meyerhenke, H. (2013). Shape Optimizing Load Balancing for MPI-Parallel Adaptive Numerical Simulations. 10th DIMACS Implementation Challenge on Graph Partitioning and Graph Clustering. pp. 67-82.
Meyerhenke, H.; B. Monien; T. Sauerwald (2008). “A New Diffusion-Based Multilevel Algorithm for Computing Graph Partitions”. Journal of Parallel Computing and Distributed Computing. 69 (9): 750-761. doi:10.1016/j.jpdc.2009.04.005.
Mogleby, Daniel, Daniel Mosesson “A New Approach for Developing Neutral Redistricting Plans.” Forthcoming. Political Analysis.
Nagel, Stuart S. 1965. “Simplified bipartisan computer redistricting.” Stanford Law Review pp. 863-899.
Naumov, M.; T. Moon (2016). “Parallel Spectral Graph Partitioning”. NVIDIA Technical Report. nvr-2016-001.
Newman, M. E. J. (2006). “Modularity and community structure in networks”. PNAS. 103 (23): 8577-8696. doi:10.1073/pnas.0601602103. PMC 1482622. PMID 16723398.
Niemi, Richard G., et al. “Measuring compactness and the role of a compactness standard in a test for partisan and racial gerrymandering.” The Journal of Politics 52.4 (1990): 1155-1181.
O'Loughlin, John and Anne-Marie Taylor. 1982. “Choices in redistricting and electoral outcomes: the case of Mobile, Ala.” Political Geography Quarterly 1(4):317-339.
O'Loughlin, John. “The identification and evaluation of racial gerrymandering.” Annals of the Association of American Geographers 72.2 (1982): 165-184.
Owen, Guillermo, and Bernard Grofman. “Optimal partisan gerrymandering.” Political Geography Quarterly 7.1 (1988): 5-22.
Pothen, Alex. “Graph partitioning algorithms with applications to scientific computing.” Parallel Numerical Algorithms. Springer Netherlands, 1997. 323-368;
Reichardt, Jorg; Bornholdt, Stefan (July 2006). “Statistical mechanics of community detection”. Phys. Rev. E. 74 (1): 016110. doi:10.1103/PhysRevE.74.016110.
Remmert, Hanna. 2016. “Blue Waters Supercomputer Used to Develop a Standard for Gerrymandering.” University of Illinois Press Release.
Sanders, P., and C. Schulz (2011). Engineering Multilevel Graph Partitioning Algorithms. Proceedings of the 19th European Symposium on Algorithms (ESA). 6942. pp. 469-480.
Shapiro, Martin. “Gerrymandering, Unfairness, and the Supreme Court.” UCLA L. Rev. 33 (1985): 227.
Sripanidkulchai, Kunwadee, Bruce Maggs, and Hui Zhang. “Efficient content location using interest-based locality in peer-to-peer systems.” INFOCOM 2003. Twenty-Second Annual Joint Conference of the IEEE Computer and Communications. IEEE Societies. Vol. 3. IEEE, 2003.
Stephanopoulos, Nicholas and Eric McGhee. 2015. “Partisan Gerrymandering and the Efficiency Gap”. University of Chicago Law Review 82: 831-900.
Stephanopoulos, Nicholas O., and Eric M. McGhee. “Partisan gerrymandering and the efficiency gap.” The University of Chicago Law Review (2015): 831-900.
Team #2048, “Congressional District Partitioning: A Two-Stage Approach”, COMAP Mathematical Contest in Modeling, Feb. 8-12, 2007.
The State Wide Database. The Institute of Governmental Studies at the University of California at Berkley. statewidedatabase.org/Thomsen, Jeppe Rishede, Man Lung Yiu, and Christian S. Jensen. “Effective caching of shortest paths for location-based services.” Proceedings of the 2012 ACM SIGMOD International Conference on Management of Data. ACM, 2012.
Trifunovic, Aleksandar, and William J. Knottenbelt. “A parallel algorithm for multilevel k-way hypergraph partitioning.” Parallel and Distributed Computing, 2004. Third International Symposium on/Algorithms, Models and Tools for Parallel Computing on Heterogeneous Networks, 2004. Third International Workshop on. IEEE, 2004.
Trifunovic, A.; W. J. Knottenbelt (2008). “Parallel Multilevel Algorithms for Hypergraph Partitioning”. Journal of Parallel and Distributed Computing. 68 (5): 563-581. doi:10.1016/j.jpdc.2007.11.002.
Vickrey, William. 1961. “On the prevention of gerrymandering.” Political Science Quarterly pp. 105-110.
Vieth v. Jubelirer, 541 U.S. 267 (2004).
Walshaw, C.; M. Cross (2000). “Mesh Partitioning: A Multilevel Balancing and Refinement Algorithm”. Journal on Scientific Computing. 22 (1): 63-80. doi:10.1137/s1064827598337373.
Wang, Samuel S-H. 2016. “Three tests for practical evaluation of partisan gerrymandering.” Stan. L. Rev. 68:1263.
Weaver, James B. and Sidney W. Hess. 1963. “A procedure for nonpartisan districting: development of computer techniques.” Yale Law Journal pp. 288-308.
Whitford v. Nichol. Case: 3:15-cv-00421. (Wisc. E.D. 2015).
Wisconsin Election Results. State of Wisconsin Government Accountability Board. www.gab.wi.gov/elections-voting/results
Woolgar, Steve, and Dorothy Pawluch. “Ontological gerrymandering: The anatomy of social problems explanations.” Social problems 32.3 (1985): 214-227.

What is claimed is:

1. A method of partitioning a map into a plurality of disjoint regions each representing a respective continuous bounded geographic region, comprising:
receiving a data set representing a map, comprising a geographic region having geographic variations, and population data associated with respective locations in the geographic region;
defining at least one partitioning objective;
successively processing the data according to an initial condition, to partition the geographic region into a plurality of districts which meet the at least one partitioning objective, according to a plurality of respectively different initial conditions, to produce a plurality of district maps, each dependent on at least the geographic variations and the initial conditions;
analyzing the plurality of partitioned geographic regions according to at least one criterion, selectively responsive to a population statistic of the population data associated with each district within the geographic region; and
determining aggregate statistical properties of the plurality of district maps.

2. The method according to claim 1, further comprising receiving a second map, comprising the geographic region having the geographic variations, partitioned into a plurality of districts, and determining a statistical relationship of the second map to the aggregate statistical properties of the plurality of district maps.

3. The method according to claim 1, wherein the at least one criterion comprises a human voting profile associated with the population data.

4. The method according to claim 3, wherein the population data comprises census data, and the human voting profile comprises historical election voting patterns.

5. The method according to claim 1, wherein said defining performs a multi-criterion optimization comprising population equality, district compactness, and conformity with geographic features of the geographic region, and the aggregate statistical properties relate to electoral voting propensity.

6. A method for partitioning a data set, representing a population geographically mapped within a space, the space having regional features, comprising:
receiving the data set, characteristics of the regional features, and characteristics of the population;
defining a set of partitioning rules or constraints;
partitioning data set, to define a set of continuously-bounded subspaces based on at least the data set, the characteristics of the regional features, and the set of partitioning rules or constraints, wherein respective partitions of the data set are disjoint, such that members of the population are allocated to a respective partition to the exclusion of being allocated to a different partition; and
assessing a quality of the partitioning according to at least one population statistic selectively dependent on the respective characterization of the population, and allocation of members of the population to respective subspaces.

7. The method according to claim 6, further comprising:
performing said partitioning of the data set a plurality of times, under a plurality of different initial conditions, to produce a plurality of alternate partitioned data sets; and
determining statistical properties of the respective quality of the plurality of alternate partitioned data sets.

8. The method according to claim 6, further comprising ranking a plurality of different partitionings of the data set.

9. The method according to claim 6, further comprising producing a statistical aggregate of a plurality of different partitions of the data set.

10. The method according to claim 6, further comprising:
performing said partitioning of the data set a plurality of times, under a plurality of different initial conditions, to produce a plurality of alternate partitioned data sets; and
statistically comparing the plurality of alternate partitioned data sets with an independently defined partitioning of the data set.

11. The method according to claim 10, wherein said statistically comparing comprises determining a likelihood of gerrymandering of the independently defined partitioning of the data set.

12. The method according to claim 6, wherein the partitioned data set is unbiased.

13. The method according to claim 6, wherein the set of partitioning rules or constraints includes at least one bias, resulting in a biased partitioned data set.

14. The method according to claim 6, wherein the set of partitioning rules or constraints is defined to optimize a voting efficiency of the population in the partitioned data set.

15. The method according to claim 6, wherein the assessing determines an optimality of a voting efficiency of the population in the partitioned data set.

16. A computer readable medium storing non-transitory instructions for causing a programmable processor to perform a method for partitioning a data set representing a map having map location features and associated population features of a population located with respect to the location features, according to at least one partitioning criterion, the non-transitory instructions comprising:
instructions for defining a respective initial condition for a partitioning;
instructions for partitioning the data set to produce a plurality of spatially-contiguous partitions of the map, based on at least the data set and the map features, dependent on the initial condition, to produce a plurality of disjoint partitions which meet the at least one partitioning criterion;
instructions for repeating the partitioning according to different respective initial conditions, to yield a plurality of different partitioned data sets; and
instructions for statistically assessing the plurality of different partitioned data sets with respect to the population features.

17. The computer readable medium according to claim 16, further comprising:
instructions for transforming the map into a series of graphs each smaller than the map;
instructions for partitioning the series of graphs into a set of partitions according to the at least one partitioning criterion and the respective initial condition;
instructions for inverting said transforming, to project the partitioned map data back to the map;
instructions for refining the projected partitioned map data according to the at least one partitioning criterion; and
instructions for testing the refined projected partitioned map data for fitness.

18. The computer readable medium according to claim 16, further comprising:
instructions for determining a statistical relationship of population features of a partitioned second map having the map features, to aggregate statistical properties of a plurality of partitioned data sets.

19. The computer readable medium according to claim 16,
wherein said instructions for partitioning the data set perform a multi-criterion optimization comprising population equality, district compactness, and conformity with the map features, and the statistically assessing relates to electoral voting propensity of the population located within respective partitions of the partitioned data set.

20. The computer readable medium according to claim 19, wherein the voting propensity is predicted based on historical election voting patterns and census data.
